(19) United States
(12) Patent Application Publication
(10) Pub. No.: US 2008/0010412 A1
(43) Pub. Date: Jan. 10, 2008

(54) Transmission apparatus, reception apparatus, transmission method, reception method, and integrated circuit

(76) Inventors: Hideki Iwata, Kyoto (JP); Toshihide Matsuda, Kyoto (JP)

Correspondence Address: MCDERMOTT WILL & EMERY LLP, 600 13TH STREET, NW, WASHINGTON, DC, 20005-3096, US

(21) Appl. No.: 11/812,553

(22) Filed: Jun. 20, 2007

(30) Foreign Application Priority Data
Jun. 21, 2006 (JP) 2006-171511
May 8, 2007 (JP) 2007-123589

(51) Int. Cl. G06F 12/00

(52) U.S. Cl. 711/128

(57) ABSTRACT

A reception apparatus is capable of correcting an error that occurs during communication according to serial communication that does not use error correction information. A repairing unit 122 in a reception circuit 117 generates two types of repaired blocks in which 1 and 0, respectively, are inserted into an error bit. A determination unit 127 employs, as a determined block, the one of the repaired blocks that matches an available block in an available block table.

### BACKGROUND OF THE INVENTION

(1) Field of the Invention

The present invention relates to serial communication of a data structure that does not have error correction information, and in particular to a technique for correcting errors and a technique for reducing the occurrence of errors.

(2) Description of the Related Art

In home AV devices such as televisions and DVD players, various types of signals are transferred according to serial communication. One example is the HDMI (High-Definition Multimedia Interface) standard which defines a method for transmitting and receiving messages relating to device control according to serial communication (CEC: Consumer Electronic Control). With this standard, information for error correction is not included in transmitted/received messages, and if an error occurs, this is dealt with by retransmitting the same message.

Furthermore, Japanese Patent Application Publication No. H8-125639 discloses a technique for dealing with occurrence of an error by transmitting the same message a plurality of times in advance.

### SUMMARY OF THE INVENTION

In this kind of serial communication in which error correction information is not included, there is a desire to be able to deal with errors without retransmitting a message, and to be able to suppress occurrence of errors.

In view of this, an object of the present invention is to provide a reception apparatus, reception method and integrated circuit that, in serial communication that does include error correction information, are capable of dealing with an error without retransmitting a message, and to provide a transmission apparatus, transmission method and integrated circuit that are capable of suppressing occurrence of errors in serial communication that does include error correction information.

In order to solve the stated problems, the present invention is a reception apparatus that receives a signal from a transmission apparatus via a signal wire, including: a storage unit operable to store a plurality of types of available blocks a reception unit operable to receive a signal that expresses a transmission bit stream, the signal expressing the transmission bit stream using, in accordance with each of pieces of bit data of the transmission bit string, two types of rectangular waves that differ from each other in terms of how long a low level period continues; a detection unit operable to, with respect to each rectangular wave in the received signal, measure how long the low level period continues and determine whether or not a piece of bit data is detectable according to the measured length, and when the piece of bit data is judged to be detectable, generate a piece of bit data corresponding to the measured low level period; a repairing unit operable to, in a reception bit string composed of the generated one or more pieces of bit data, insert, into a bit position corresponding to a rectangular wave for which a piece of bit data is judged to be undetectable, a bit value 0 to generate a first repaired block and a bit value 1 to generate a second repaired block; and a selection unit operable to search the storage unit for one or more available blocks matching at least one of the first repaired block and the second repaired block, and when an available block is found that matches one of the repaired blocks and no available block is found that matches the other one of the repaired blocks, select the one of the repaired blocks for which the matching available block was found.

Here, a storage unit 123 in a first embodiment has the function of the above-mentioned “storage unit”. Furthermore, an input/output unit 101, a decoding unit 120, a repairing unit 122 and determination unit 127 have the respective functions of the above-mentioned “reception unit”, “detection unit”, “repairing unit”, and “selection unit”.

According to the stated structure, the storage unit stores in advance a plurality of types of available blocks. Here, the available blocks are data transmitted and received between the transmission apparatus and the reception apparatus as determined by the Standard. The transmission bit string matches one of the available blocks.

Only when a matching available block exists for one of the first and second repaired blocks generated by the repairing unit and a matching available block does not exist for the other of the first and second repaired blocks, the determination unit selects the one of the repaired blocks for which a matching available block exists. Therefore, a repaired block that matches the transmission bit string transmitted by the transmission apparatus can be selected accurately. As a result, when an error occurs when receiving a transmission bit string, the reception apparatus of the present invention is able to correct the error accurately itself, and has a superior advantage of being capable of acquiring an accurate bit string without the bit string being retransmitted.

Furthermore, the storage unit may store one or more available block tables identified by (i) identification information showing a device to which the reception apparatus is connected via a signal wire, and (ii) status information showing an operational status of the reception apparatus, each of the available blocks corresponding respectively to the available block tables, and the selection unit may include: a status acquiring sub-unit operable to acquire status information showing a current operational status of the reception apparatus; an identification sub-unit operable to acquire device identification information identifying the transmission apparatus; a selection sub-unit operable to select, from among the stored available block tables, one available block table identified by the acquired status information and the acquired device identification information; and a search unit operable to search selected available block table for one or more available blocks matching at least one of the first repaired block and the second repaired block, and when an available block is found that matches one of the repaired blocks and no available block is found that matches the other one of the repaired blocks, select the one of the repaired blocks for which the matching available block was found.

According to the stated structure, the selection sub-unit selects an available block table corresponding to the status information and the transmission origin, and the search sub-unit selects a repaired block with use of the selected available block table.

If the device that transmitted the data and the current operational status of the reception-side device can be determined, data can be narrowed down to data with a high possibility of being transmitted. With the stated structure, the transmitted bit string can be acquired more accurately and promptly.

Furthermore, the present invention is a reception apparatus that receives, from a transmission apparatus via a signal wire, a rectangular wave including a low level period corresponding to a piece of bit data, and corrects an error that occurs in the received rectangular wave, including: a reception unit operable to receive the rectangular wave; a measuring unit operable to measure a length of the low level period of the received rectangular wave; a conversion unit operable to generate a first value when the measured length falls within a first range, and generate a second value when the measured length falls within a second range, the second range including a lower limit value that is greater than an upper limit value of the first range; and a repairing unit operable to, when the measured length falls within neither of the first range and the second range, (a) lower a lower limit value of the first range to extend the first range, determine whether or not the measured length falls within the extended first range, and when it is determined that the measured length falls within the extended first range, generate the first value, and (b) raise the upper limit value of the second range to extend the second range, determine whether or not the measured length falls within the extended second range, and when it is determined that the measured length falls within the extended second range, generate the second value.

Here, an input/output unit in the following second embodiment has the function of the above-mentioned “reception unit”. A decoding/repairing unit 232 has the functions of the “measuring unit”, the “conversion unit” and the “repairing unit”.

According to the stated structure, the repairing unit generates a first value if the measured low level period falls within the extended first range, and generates a second value if the measured low level period falls within the extended second range. Therefore, the reception apparatus of the present invention has the superior advantage of being able to perform error correction with respect to individual bits.

Furthermore, the present invention is a transmission apparatus that transmits, to a reception apparatus via a signal wire, a rectangular wave including a low level period corresponding to a piece of bit data, including: a signal output unit operable to repeatedly perform generation and output of a rectangular wave that includes a low level period corresponding to apiece of bit data; a judgment unit operable to judge whether or not an error has occurred in the transmitted rectangular wave; and a timing adjustment unit operable to, when an error is judged to have occurred in the transmitted rectangular wave, cause the signal output unit to shorten a length of the low level period.

Here, a signal output unit 138, a result determination unit 139 and a timing adjustment unit 141 of the first embodiment below have the respective functions of the above-described “signal output unit”, “determination unit”, and “timing adjustment unit”.

According to the stated structure, when an error is determined to have occurred, the signal output unit shortens the low level period of the generated rectangular wave according to control by the timing adjustment unit.

When a rectangular wave is transmitted over a signal wire, dispersion in the wave form occurs on the signal wire. Dispersion also occurs when voltage drops from high level to low level, and when voltage rises from low level to high level, with dispersion being more pronounced in the latter case. For this reason, the low voltage period of the signal recognized by the reception-side device is longer than the low voltage period of the signal output by the transmission-side device, and therefore an error occurs (.refer to the preferred embodiments below for details of the occurrence of errors). Therefore, the transmission apparatus of the present invention has the superior advantage of being able to suppress the occurrence of errors by shortening the length of the low voltage period of a generated rectangular wave in advance.

Furthermore, the present invention is a reception apparatus that receives a signal from a transmission apparatus via a signal wire, including: a test reception unit operable to receive a test signal generated using, in accordance with each of test bits that compose test data, two types of rectangular waves that differ from each other in terms of how long a low level period continues; a detection unit operable to detect dispersion of the low level period of each rectangular wave composing the received test signal; a generation unit operable to generate a correction value based on dispersion detected with respect to all the rectangular waves; and a correction unit operable to, using the correction value, correct each rectangular wave in the signal received from the transmission apparatus.

Here, a reception unit 302, a detection unit 303, a learning unit 306 and a correction unit 304 in a third embodiment below have the respective functions of the above-mentioned “test reception unit”, “detection unit”, “generation unit”; and “correction unit”.

According to the stated structure, for each bit, the difference in low level periods is calculated between corresponding bits of (a) test data that is identical to the signal generated on the transmission-side and (b) the test data transmitted via the communication path. The calculated differences are averaged to generate a correction value. In this way, by calculating in advance the low level period dispersion that occurs according to transmission/reception, when performing actual transmission/reception of data, data can be transferred accurately by using the generated correction value.

Furthermore, the detection unit may store the test data and a low level period of each test bit, and, for each rectangular wave in the test signal, detects, as the dispersion, a difference between the low level period of the rectangular wave and the low level period of a corresponding one of the test bits, and the generation unit may generate the correction value by averaging all of the differences detected with respect to the rectangular waves composing the test signal.

According to the stated structure, the detection unit is able to calculate dispersion by a simple calculation of subtraction. Furthermore, the correction unit can perform correction easily and promptly by adding or subtracting the correction value to or from the low level period or high level period of a rectangular wave in a received signal.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a block diagram showing the structure of a DVD player 100 and a television 300 in a transmission/reception system of a first embodiment;

FIG. 2A shows the structure of a message including device control information, and FIG. 2B shows a signal generated by converting the message;

FIGS. 3A to 3C show bit pulses corresponding to a start bit, and bit data “0” and “1”, respectively;

FIG. 4 is a block diagram showing the structure of a reception circuit 117 and a transmission circuit 135 in a device control signal processing unit 104;

FIG. 5 shows a specific example of error bit repair processing by the reception circuit 117;

FIG. 6A shows a waveform of a signal output by a transmission side, FIG. 6B shows a waveform of the signal on a signal wire, and FIG. 6C shows a waveform of the signal as detected on the transmission-side;

FIGS. 7A and 7B show the waveform of a bit pulse before and after offset adjustment processing by the transmission circuit 135;

FIG. 8 is a flowchart showing operations for message reception;

FIG. 9 is a flowchart showing operations for message reception, and continues from FIG. 8;

FIG. 10 is a flowchart showing operations for message transmission;

FIG. 11 is a block diagram showing the structure of a reception circuit 228 in a second embodiment;

FIG. 12 shows the relationship between a low level period T of a bit pulse, and bit data output by the reception circuit 228 in accordance with the bit pulse;

FIG. 13 is a flowchart showing operations for message reception;

FIG. 14 is a block diagram showing the structure and data flow of a reception circuit 301 of a third embodiment;

FIG. 15 shows correction of a signal by a correction unit 304 visually;

FIG. 16 is a flowchart showing operations for correction value determination;

FIG. 17 is a flowchart showing operations for message reception after correction value determination;

FIG. 18 is a block diagram showing a reception circuit 401 and a control unit 406 of a modification example (2);

FIGS. 19A to 19C show an example of information stored in a storage unit 405; and

FIG. 20 is a flowchart showing message reception operations in the modification example (2).

### DESCRIPTION OF THE PREFERRED EMBODIMENTS

### 1. First Embodiment

The following describes a transmission/reception system of a first embodiment of the present invention with reference to the drawings.

1.1 Overview

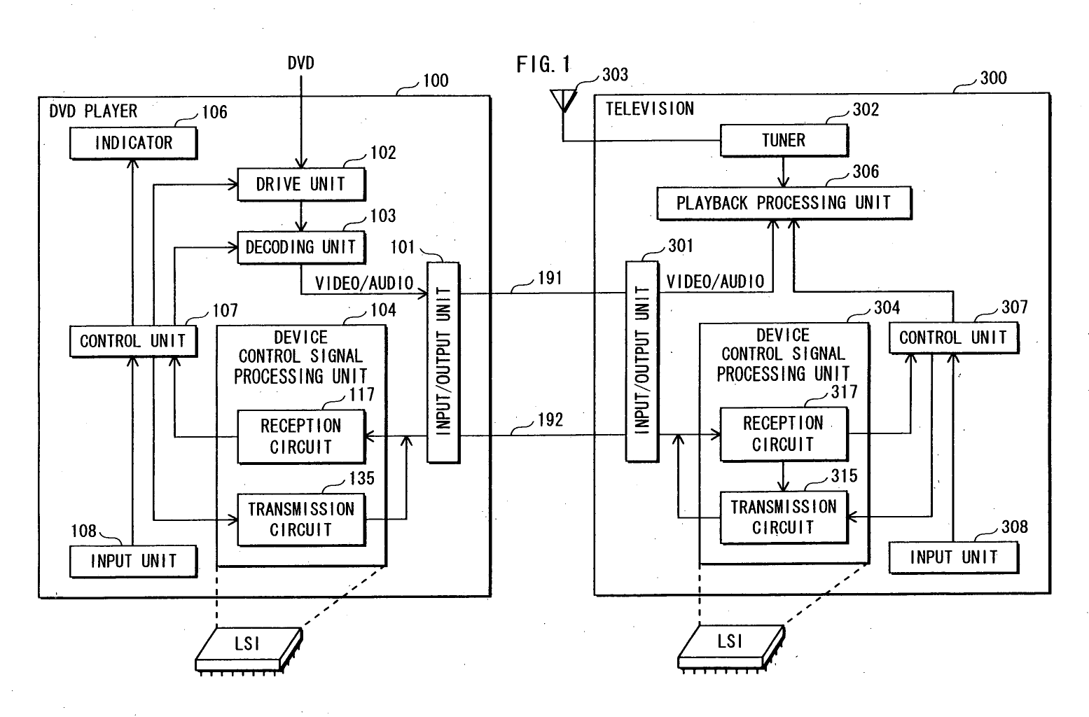

FIG. 1 is a function block diagram showing the functional structure of a DVD player 100 and a television 300 that compose the transmission/reception system. Although the transmission/reception system is described as being composed of these two devices for simplicity in the present embodiment, the transmission/reception system may be composed of a greater number of devices connected by daisy chain or tree wiring.

The DVD player 100 and the television 300 comply with the HDMI standard, and both include a device control signal processing unit having identical functions. The DVD player 100 and the television 300 are connected to each other by a cable that complies with the HDMI standard.

The DVD player 100 is structured so as to be able to have mounted therein a DVD on which digital content composed of video and music is recorded. The DVD player 100 has a function of transmitting and receiving data and information relating to device control to and from the television 300, and reading content from a DVD and outputting the read content to the television 300. Here, the transmission and reception of the information relating to device control is performed using serial communication that does not include error correction information. Examples of the information relating to device control include an activate instruction and a content read instruction. Hereinafter, the information relating to device control that is transmitted and received according to serial communication is simply referred to as messages.

The television 300 has a function of displaying a television broadcast or playing back content recorded on a DVD, in accordance with an operation by a user. When content playback is instructed according to a user operation, the television 300 transmits a message showing an activation instruction to the DVD player 100, and then plays back content read by the DVD player 100.

Other messages besides those described are also transmitted and received between the DVD player 100 and the television 300. When an error exists in a message received by the device on the reception side, the device tries to repair the received message. If the received message is repaired successfully, the reception side device determines that reception has been successful, and outputs an ACK signal showing reception success. If the repairing fails, the reception-side device does not output an ACK signal.

When the device on the transmission side does not receive an ACK signal showing reception success, the transmission-side device judges that message transmission has failed, and re-transmits the same message. When retransmitting a message, the transmission-side device shortens the low level period of each bit pulse by a predetermined amount of time.

1.2 DVD player 100

As shown in FIG. 1, the DVD player 100 is composed of an input/output unit 101, a drive unit 102, a decryption unit 103, a device control signal processing unit 104, an indicator 106, a control unit 107 and an input unit 108.

In concrete terms, the DVD player 100 is computer system that includes a microprocessor, a RAM, a ROM, and so on. Computer programs are stored in the RAM and the ROM, and the DVD player 100 achieves part of its functions by the microprocessor operation in accordance with the programs.

The following describes each of the compositional elements of the DVD player 100.

(1) Input/Output Unit 101

The input/output unit 101 includes a terminal to which an HDMI standard-compliable cable is connectable. The input/output unit 101 performs transmission and reception of information between an external device connected via the cable and the units composing the DVD player 100. The cable includes multiple signal wires, but for simplicity only a signal wire 191 and a signal wire 192 are mentioned here. The signal wire 191 is for transmitting and receiving video and audio that compose content, and the signal wire 192 is for transmitting and receiving messages relating to device control.

Referring to the drawings, a description is now given of the structure of a message transmitted and received between the external apparatus and the device control signal processing unit 104 and the structure of a signal corresponding to the message.

Message Structure

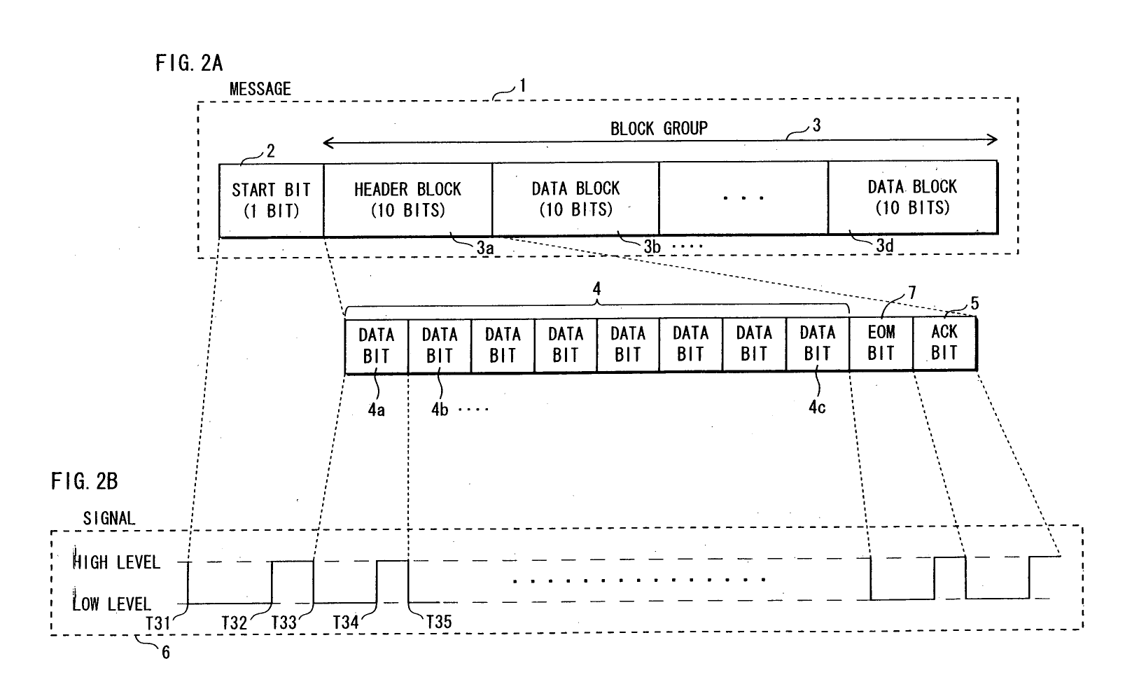

FIG. 2A shows the structure of a message 1 defined by the HDMI standard.

As shown in FIG. 2A, the message 1 is composed of a start bit 2 and a block group 3. The start bit 2 is data that is one bit in length and signifies the start of the message 1. The block group 3 is composed of a header block 3a, and data blocks 3b . . . 3d. The header block 3a is positioned directly after the start bit 2, and includes the address of the transmission origin of the message 1 and the address of the transmission destination of the message 1. The transmission-origin address is included in the first four bits, and the transmission-destination address is included in the subsequent four bits. Although these addresses are basically determined in accordance with the type of the respective device, when both devices are of the same type, the addresses are set to respectively different values.

The data block 3b, which is directly after the header block 3a, includes a command relating to device control, and subsequent data blocks include data used is execution of the command.

The header block 3a and the data blocks 3b. . . . 3d have the same data structure, and therefore each is referred to simply as a block unless it is necessary to make a distinction between a header block and a data block.

The block 3a is ten bits in length, and is composed of a data bit group 4, and EOM bit 7, and an ACK bit 5. The data bit group 4 includes eight bits of data, namely data bits 4a, 4b . . . 4c.

The EOM bit 7 shows whether or not the block is the last block of the message 1. The ACK bit 5 is used for reception response for the data bit group 4, and the transmission-side device transmits bit data “1”.

FIG. 2B shows a signal 6 generated by converting the message 1. The horizontal axis represents time, and the vertical axis represents voltage.

The voltage of the signal 6 drops from high level to low level at a time T31, and rises from low level to high level at a time T32. The voltage then drops from high level to low level again at time T33. The section of the signal 6 from the time T31 to the time T33 corresponds to the start bit 2. The voltage of the signal 6 is maintained at low level until a time T34, and then rises from low level to high level at the time T34. At a time T35, the voltage again drops from high level to low level. The section of the signal 6 from the time T33 to the time T35 corresponds to the data bit 4a. Each subsequent section starting at a time at which the voltage drops and ending at a time at which the voltage next drops corresponds of one the bits.

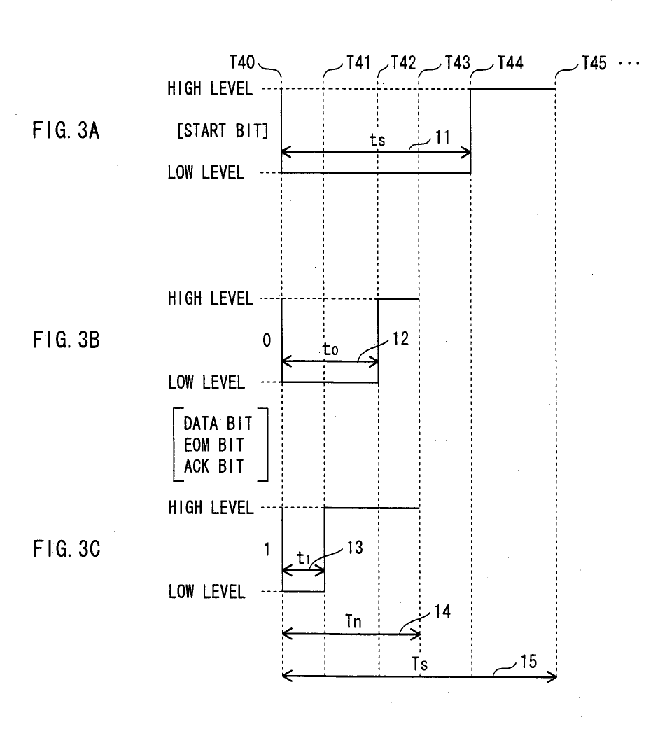

Referring now to FIGS. 3A to 3C, a description is given of a bit pulse used in serial communication (hereinafter a signal corresponding to one bit is referred to as a bit pulse). In FIGS. 3A to 3C, a bit pulse corresponding to the start bit, and a bit pulse corresponding to data bits, the EOM bit and the ACK bit are shown in parallel. The horizontal axis represent time, and the vertical axis represents voltage.

FIG. 3A shows the bit pulse corresponding to the start bit. As shown in FIG. 3A, the voltage of the bit pulse of the start bit drops from high level to low level at a time T40, rises from low level to high level at a time T44, and is maintained at high level until a time T45. The period of time from the time T40 to the time T45 is a bit period 15 “Ts” that corresponds to the start bit (hereinafter, a period of time corresponding to one bit is called a bit period). Furthermore, the period of time from the time T40 to the time T44 is a low level period 11 “ts” of the bit pulse corresponding to the start bit.

Bit data “1” or bit data “0” is stored in the data bit group 4, the EOM bit 7 and the ACK bit 5. FIG. 3B shows the bit pulse corresponding to bit data “0”. In the bit pulse corresponding to the bit data “0”, the voltage drops from high level to low level at the time T40, rises from low level to high level at the time T42, and is maintained at high level until the time T43. Here, the period of time from the time T40 to the time T42 is a low level period 12 “t0” of the bit pulse showing the bit data “0”.

As shown in FIG. 3C, in the bit pulse showing the bit data “1”, the voltage drops from high level to low level at the time T40, is maintained at low level until time T41, rises from low level to high level at the time T41, and is maintained at high level until the time T43. Here, the period of time from the time T40 to the time T41 is a low level period 13 “t1” of the bit pulse showing the bit data “1”.

The period of time from the time T40 to the time T43 is a bit period 14 “Tn” allocated to the data bits, the EOM bit and the ACK bit.

The aforementioned bit period and the low level period of each bit pulse are defined by the HDMI standard, and satisfy the relationship

Ts>ts>Tn>t0>t1>0.

The signal 6 shown in FIG. 2B is composed of bit pulses generated in accordance with the bit period and low level period defined by the HDMI standard. Note that the voltage of the signal wire is maintained at high level when transmission and reception of data is not being performed.

After detecting the start bit, the reception-side device decodes each one section of the signal that corresponds to a block, in order to generate blocks. More specifically, the reception-side device measures a low level period of each bit pulse included in a section corresponding to a single block, and if the measured low level period is in the vicinity of the low level period “t0”, generates bit data “0”. If the measured low level period is in the vicinity of the low level period “t1”, the reception-side device generates bit data “1”.

Note in the present specification, a state of being unable to determine whether bit data is “1” or “0” based on the measured low level period is called an error.

If no error is detected in any of the bits in the data bit group 4 composing the block when decoding, the reception-side device transmits a bit pulse of bit data “0” when the timing of the ACK bit 5 occurs.

When the transmission-side device that transmitted the message does not detect an ACK signal shown bit data “0” when the timing of the ACK bit 5 occurs, the transmission-side device determines that an error has occurred in the transmitted block, and retransmits the message. (2) Drive unit 102 and decryption unit 103 The drive unit 102 has a function of reading information from a DVD. Under the control of the control unit 107, the drive unit 102 reads content from the DVD, and outputs the read content to the decryption unit 103. The content read here is a digital work such as a movie that has been encoded using an MPEG 2 method and then subjected to encryption processing.

Under the control of the control unit 107, the decryption unit 103 decrypts and expands the content output from the drive unit 102, to generate video and audio data, and outputs the generated video and audio data via the input/output unit 101.

(3) Control Unit 107

The control unit 107 controls operations of the units of the DVD player 100 in accordance with messages decoded by the device control signal processing unit 104 and operation instruction information output from the input unit 108.

In particular, the control unit 107 outputs a message to be transmitted to the television 300 to the device control signal processing unit 104 (described below), and instructs that the message be transmitted. After instructing message transmission, if the control unit 107 receives notification from the transmission circuit 135 that an error in message transmission cannot be avoided, the control unit 107 notifies the user that a communication error has occurred, by, for instance, causing the indicator 106 to flash.

(4) Indicator 106 and Input Unit 108,

The indicator 106 is composed of an LED lamp, and illuminates, extinguishes and flashes under the control of the control unit 107.

The input unit 108 includes various types of buttons such as a playback button, and outputs operation instruction information showing a button operation by the user to the control unit 107.

(5) Device Control Signal Processing Unit 104

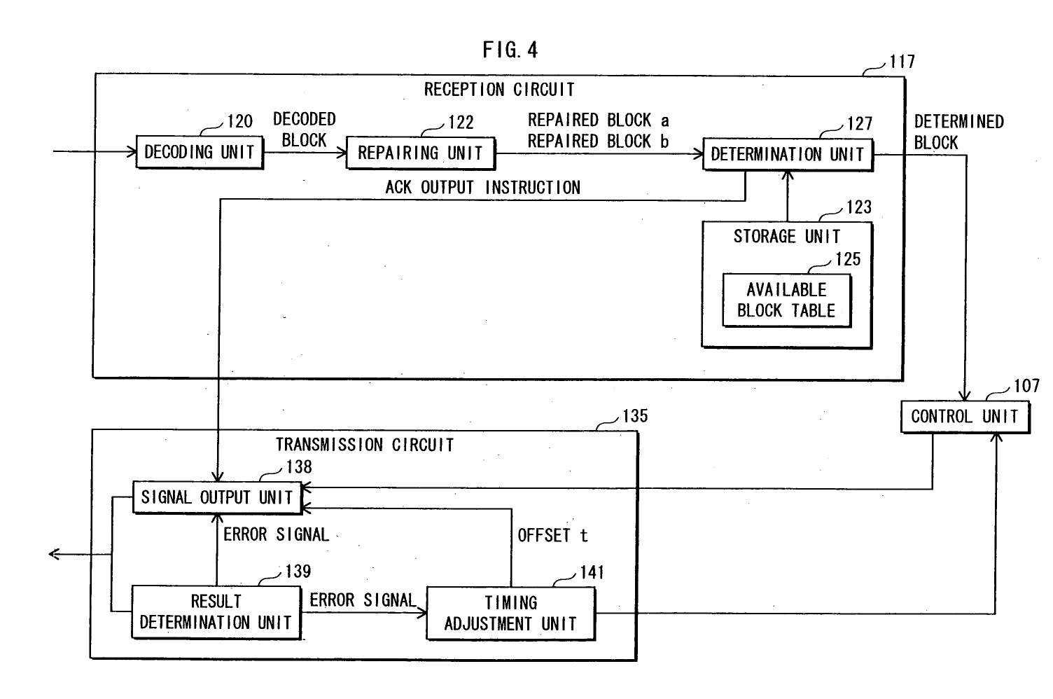

The device control signal processing unit 104 is an integrated circuit formed on a single chip, and includes the reception circuit 117 and the transmission circuit 135 as shown in FIG. 1. FIG. 4 is a function block diagram showing the structure of the reception circuit 117 and the transmission circuit 135.

(5-1) Structure of Reception Circuit 117

As shown in FIG. 4, the reception circuit 117 is composed of a decoding unit 120, a repairing unit 122, a determination unit 127, and a storage unit 123.

(5-1-a) Storage Unit 123

The storage unit 123 stores an available block table 125. The available block table 125 includes a plurality of available blocks. Each available block is 8 bits in length, and is a command or data relating to device control defined by the HDMI specification. The available block table 125 includes all available blocks transmitted and received between the DVD player 100 and the television 300.

(5-1-b) Decoding Unit 120

The decoding unit 120 decodes each bit pulse included in the signal input from the signal wire 192 via the input/output unit 101, thereby generating bit data.

More specifically, the decoding unit 120 monitors the voltage of the signal wire, and detects falls and rises in the voltage. Upon detecting a fall in the voltage, in other words, the start of a bit pulse, the decoding unit 120 starts measuring the low level period T. Upon detecting a rise in the voltage, the decoding unit 120 stops measuring. If the measured low level period T satisfies

ts−α≦T≦ts+α,

the decoding unit 120 determines that the bit pulse is a start bit showing the start of a message. If the measured low level period T satisfies

t1−α≦T≦t1+α,

the decoding unit 120 determines that the bit pulse shows “1”, and generates bit data “1”. If the measured low level period T satisfies

t0−α≦T≦t0+α,

the decoding unit 120 determines that the bit pulse shows “0”, and generates bit data “0”. Note that ±α is a permissible range of the low level period that is defined by the HDMI standard.

When the measured low level signal T is included in none of the ranges ts−α≦T≦ts+α, t1−α≦T≦t1+α and t0−α≦T≦t0+α, the decoding unit 120 determines that the bit pulse cannot be decoded.

If the decoded bit pulse is a start bit, the decoding unit 120 decodes each bit pulse included in the section corresponding to one block following the start bit, and temporarily stores the bit data. When the bit pulses corresponding to the first to ninth bits have been decoded, the decoding unit 120 outputs, to the repairing unit 122, a decoded block which is a bit data group composed of the first to eighth bits from among the stored first to ninth bits. The decoding unit 120 performs this generating and outputting of decoded blocks similarly for each section corresponding to one block.

When a bit pulse that cannot be decoded is included in a section corresponding to one block of a received signal, the decoding unit 120 inserts “0” in the bit corresponding to the undecodable bit pulse (hereinafter referred to as an error bit), and generates bit position information showing the position of the bit in the block (e.g., the fourth bit). The decoding unit 120 then outputs the generated decoded block and the bit position information to the repairing unit 122.

Note that although each one block is ten bits in length, the decoding unit 120 excludes the last two bits, namely the EOM bit and the ACK bit, to output eight bits of data as a decoded block. Furthermore, when the bit data of the EOM bit shows that the block is the last block of the message, the decoding unit 120 ends the generating and output of decoded blocks.

(5-1-c) Repairing Unit 122

The repairing unit 122 acquires an 8-bit decoded block and bit position information from the decoding unit 120, or acquires only a decoded block.

Upon acquiring a decoded block, the repairing unit 122 counts how many pieces of bit position information were acquired together with the decoded block.

If the number of acquired pieces of bit information is 0, the repairing unit 122 outputs the acquired decoded block as is to the determination unit 127.

If the number of acquired pieces of bit information is 2 or greater the repairing unit 122 notifies the determination unit 127 that the error bit cannot be repaired.

If the number of acquired pieces of bit information is 1, the repairing unit 122 inserts “0” and “1”, respectively, into the error bit shown by the piece of bit position information. Hereinafter, a data block in which “0” has been inserted in an error bit is referred to as a repaired block a, and a data block in which “1” has been inserted into an error bit is referred to as a repaired block b.

The repairing unit 122 then outputs the generated repaired block a and repaired block b to the determination unit 127.

(5-1-d) Determination Unit 127

The determination unit 127 receives notification from the repairing unit 122 that repairing cannot be performed, or acquires only a decoded block from the repairing unit 122, or acquires a repaired block a and a repaired block b from the repairing unit 122.

In the case of receiving notification that repairing cannot be performed, the determination unit 127 instructs the decoding unit 120 to stop generating decoded blocks (in other words, to stop receiving messages).

In the case of receiving a decoded block only, the determination unit 127 outputs the acquired decoded block to the control unit 107 as a determined block (hereinafter, each block output from the determination unit 127 is referred to as a determined block).

In the case of acquiring the repaired block a and the repaired block b, the determination unit 127 reads the available block table 125 from the storage unit 123. The determination unit 127 compares the available blocks in the read available block table 125 with the acquired repaired block a and repaired block b, and searches for one or more available blocks matching the repaired block a and/or the repaired block b.

When an available block that matches one of the repaired blocks is found, the determination unit 127 outputs the one of the repaired blocks for which the matching available block was found to the control unit 107 as a determined block. At the same time as outputting the determined block, the determination unit 127 also instructs the transmission circuit 135 to output an ACK signal “0”.

When a matching available block exists for neither of the repaired block a and the repaired block b in the available block table 125, or when both an available block matching the repaired block a and an available block matching the repaired block b exist in the available block table 125, the judgment unit 127 instructs the decoding unit 120 to stop generating decoded blocks (in other words, to stop receiving messages).

(5-2) Specific Example of Repair Processing

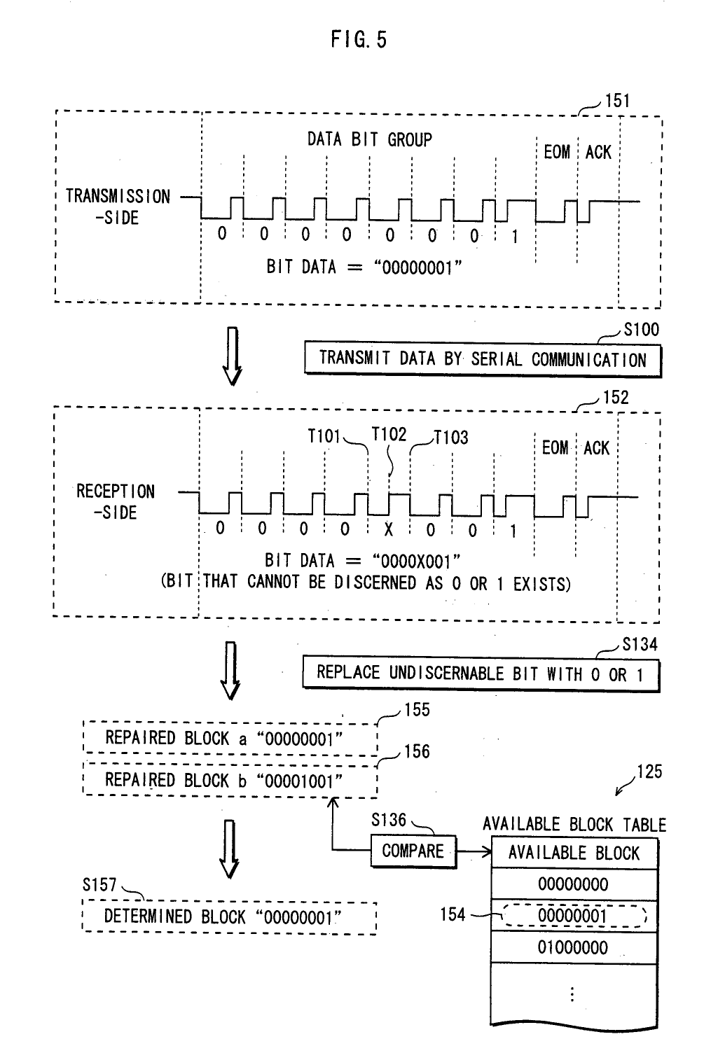

FIG. 5 shows a specific example of repair processing of error bits executed by the reception circuit 117. In the present example, the television 300, which is the transmission-side device, transmits a signal 151 that has been generated by converting a bit data string “00000001” (step S100).

A signal 152 shows the waveform of a signal as recognized by the decoding unit 120, with the horizontal axis representing time. At a time T101, the decoding unit 120 recognizes a drop in voltage, in other words the start of the bit pulse of the fifth bit, and at a time T102, recognizes a rise in voltage. Accordingly, the period of time from the time T101 to the time T102 is a low level period corresponding to the fifth bit. It is assumed at this time that the measured low level period is not included in the range of t1−α to t1+α or the range of t0−α to t0+α, and the decoding unit 120 cannot determine which of 1 and 0 the fifth bit data is. In FIG. 5, “X” denotes the bit data of the fifth bit.

The repairing unit 122 inserts “1” and “0”, respectively, into the bit that could not be distinguished as a result of the decoding by the decoding unit 120, to generate a repaired block a 155 “00000001” and a repaired block b 156 “00001001” (step S134).

The determination unit 127 compares the generated repaired block a 155 and repaired block b 156 with the available blocks in the available block table 125 (step S136). In the present example, it is assumed that an available block 154 in the available block table 125 matches the repaired block a 155, and that an available block matching the repaired block b 156 does not exist.

The determination unit 127 outputs the repaired block a 155 to the control unit 107 as a determined block 157 “00000001”.

As a result, the reception circuit 117 obtains the bit data string “00000001” that was transmitted by the transmission-side device.

(5-3) Transmission Circuit 135

As shown in FIG. 4, the transmission circuit 135 is composed of a signal output unit 138, a result determination unit 139, and a timing adjusting unit 141.

Here, before describing the elements of the transmission circuit 135, a description of how errors occur is given with reference to the drawings in order to assist comprehension of the functions of the elements of the transmission circuit 135.

(5-3-a) Causes of Error Occurrence

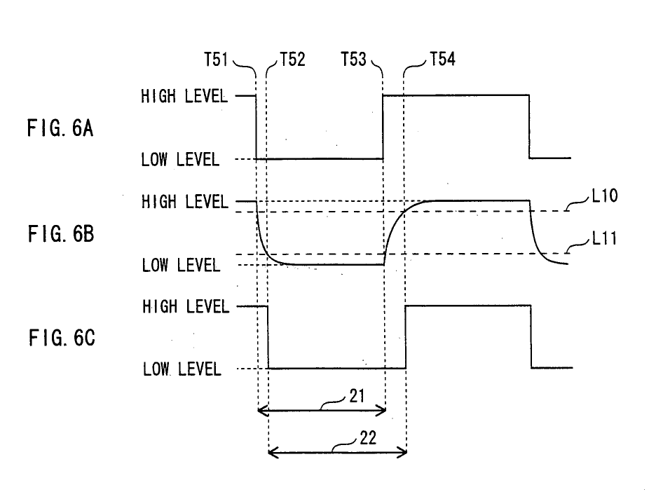

FIG. 6A shows the waveform of a signal that the transmission-side device outputs to a signal wire, FIG. 6B shows the waveform of the signal on the signal wire, and FIG, 6C shows the waveform of the signal recognized by the reception-side device. In each of FIGS. 6A to 6C, the horizontal axis represents time and the vertical axis represents voltage. The horizontal axis is consistent across the three figures.

As shown in FIG. 6A, the transmission-side device drops the voltage applied to the signal wire from high level to low level at the time T51, and raises the voltage from low level to high level at the time T53. Accordingly, the signal output by the transmission-side device is a block pulse as shown in FIG. 6A. As shown in FIG. 6B, however, dispersion occurs in the waveform during transmission.

When the transmission-side device drops the applied voltage to low level at the time T51, the voltage of the signal wire drops extremely steeply, but after the vicinity of the time T52, the voltage of the signal wire drops gently to reach low level. Furthermore, when the transmission-side device raises the applied voltage to high level at the time T53, the voltage of the signal wire also rises steeply, but after the time T54, the voltage of the signal wire continues its rise gently, and then reaches high level.

The reception-side device monitors the voltage of the signal wire, and at the time T52 that the voltage of the signal wire has dropped to a voltage L11, recognizes that the voltage of the transmitted signal has dropped from high level to low level. Furthermore, at the time T54 that the voltage of the signal wire has risen to a voltage L10, the reception-side device recognizes that the voltage of the transmitted signal has risen from low level to high level.

As described, signal dispersion on the signal wire occurs both when the voltage drops and when the voltage rises, but due to the circuit structure, dispersion is more pronounced when the voltage rises from low level to high level than when the voltage drops from high level to low level.

For this reason, comparing the low level period 21 of the signal output at the transmission side and the low level period 22 of the signal recognized at the reception side, the low level period 22 is longer than the low level period 21.

In addition, the difference between the low level period 21 and the low level period 22 increases depending on how many devices are connected to the signal wire between the transmission-side device and the reception-side device.

When the difference between the low level periods 21 and 22 exceeds a permissible range, an error occurs because the reception-side device is unable to determine the correct bit data.

(5-3-b) Signal Output Unit 138

The signal output unit 138 receives a message output from the control unit 107. Upon receiving the message, the signal output unit 138 generates bit pulses corresponding to the start bit and each bit data, and outputs a signal composed of the generated bit pulses to the signal wire 192 via the input/output unit 101.

When generating a bit pulse, the signal output unit 138 acquires an offset t output from the timing adjustment unit 141, and subtracts the offset t from each of the low level periods ts, t0 and t1 defined by the standard, to calculate ts-t, t0-t, and t1-t. The signal output unit 138 generates the bit pulse using the calculated ts-t, t0-t and t1-t as the low level period of the start bit, the low level period of bit data “0”, and the low level period of bit data “1”, respectively. The offset t is a variable that has an initial value of 0, and varies between 0 and an offset threshold value Tmax (described below).

Furthermore, there are cases in which the signal output unit 138 receives an error signal showing transmission failure from the result determination unit 139 while transmitting a signal corresponding to a message. When an error signal is received, the signal output unit 138 stops signal generating and transmitting. Next, the signal output unit 138 receives a new offset t from the timing adjustment unit 141, and using the new offset t, re-generates and re-outputs the bit pulse in order from the start bit.

In addition, the signal output unit 138 receives an instruction to output an ACK signal from the determination unit 127 of the reception circuit 117. Upon receiving the ACK signal output instruction, the signal output unit 138 outputs an ACK signal of bit data “0”.

(5-2-c) Result Determination Unit 139

The result determination unit 139 monitors the voltage of the signal wire via the input/output unit 101 while the signal output unit 138 outputs a signal corresponding to a message. When unable to detect an ACK signal of bit data “0” from the reception-side device at the ACK bit timing, the result determination unit 139 outputs an error signal showing that transmission has failed to the timing adjustment unit 141 and the signal output unit 138.

(5-2-d) Timing Adjustment Unit 141

The timing adjustment unit 141 stores the offset t, and outputs the offset t to the signal output unit 138.

In addition, the timing adjustment unit 141 stores a predetermined adjustment time Δt and the offset threshold value Tmax. The adjustment time Δt is sufficiently smaller than the low level period “t1” of the bit pulse showing bit data “1”. The offset threshold value Tmax is an upper limit value of the offset t predicted to enable the reception-side device to accurately distinguish the respective bit pulses of the start bit and bit data “1” and “0” when the respective bit pulses of the start bit and bit data “1” and “0” are generated with the offset t added thereto.

The timing adjustment unit 141 receives an error signal from the result determination unit 139. Upon receiving the error signal, the timing adjustment unit 141 adds the adjustment time Δt to the offset t, and compares the resultant offset t with the offset threshold value Tmax. If the comparison shows that t≦Tmax, the timing adjustment unit 141 outputs the offset t to which the adjustment time Δt has been added to the signal output unit 138. If t>Tmax, the timing adjustment unit 141 notifies the control unit 107 that an error cannot be avoided by adjusting the offset t.

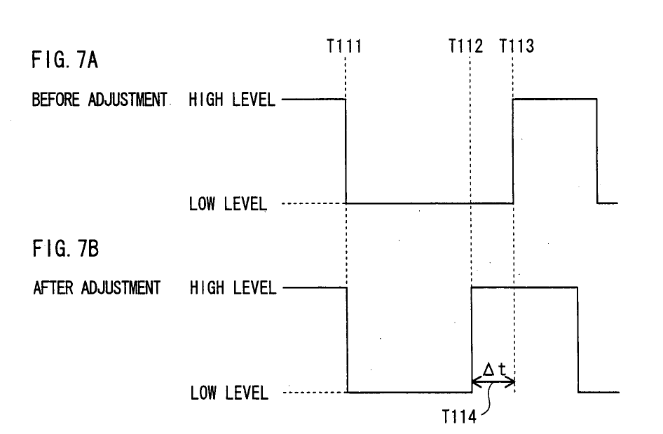

FIG. 7A and FIG. 7B show an example of a signal output by the signal output unit 138 before and after adjustment of the offset t. In both FIG. 7A and FIG. 7B, the vertical axis represents voltage and the horizontal axis represent time, the horizontal axis being consistent between the two figures.

In the signal before adjustment, the voltage drops from high level to low level at a time T111, and rises from low level to high level at time T113. In the signal after adjustment, the voltage drops from high level to low level at the time T111, and rises from low level to high level at a time T112 which comes an amount of time T114 “Δt” before a time T113.

(6) Operations for Transmitting and Receiving a Device Control Signal

Referring to the drawings, the following describes operations by the DVD player 100 for receiving and transmitting a message.

Reception Operations

The device control signal processing unit 104 of the DVD player 100 monitors the voltage of the signal wire 192 via the input/output unit 101, and upon detecting the start of a message, starts receiving the message as follows.

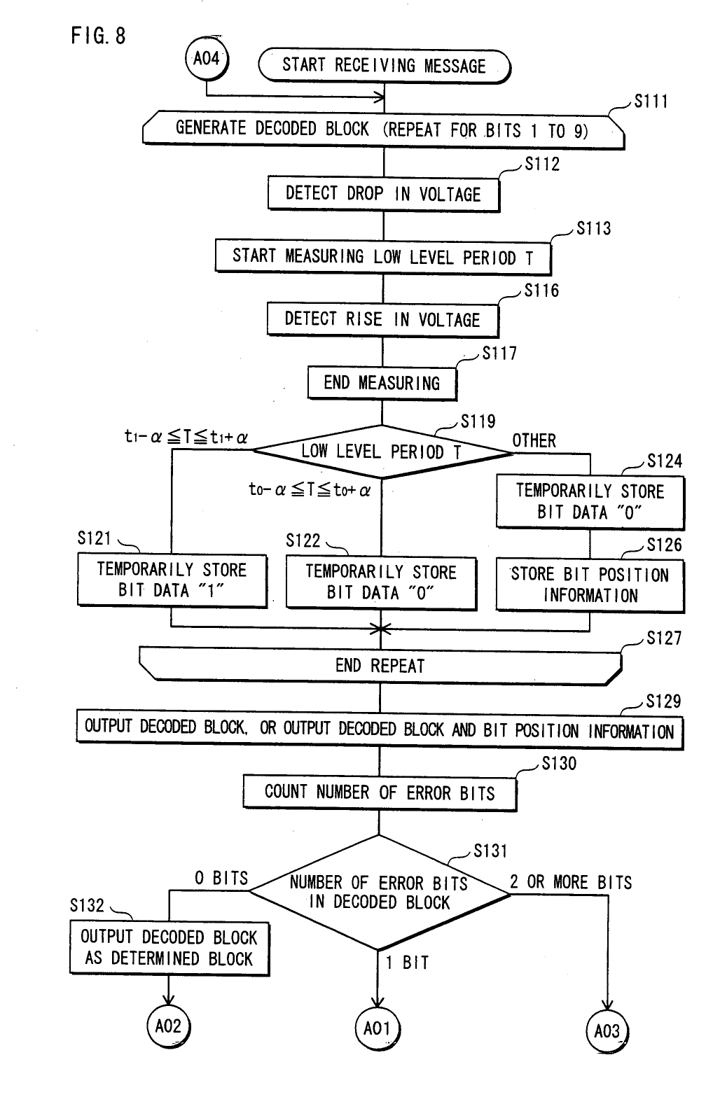

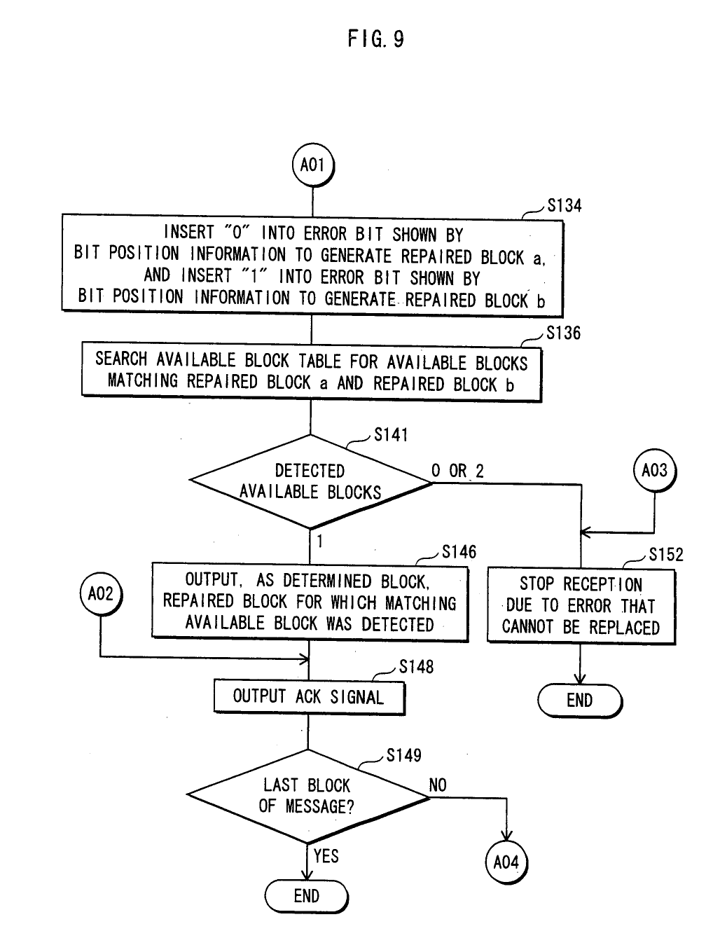

FIG. 8 and FIG. 9 are a flowchart showing operations for receiving a message. The following refers to FIG. 8 and FIG. 9 to describe the operations for receiving a message. Note that processing corresponding to the specific example of repair processing described with use of FIG. 5 has the same step numbers as used in FIG. 5.

Between steps S111 to S127, in other words, in a section corresponding to one block of a signal input via the input/output unit 101, the decoding unit 120 of the reception circuit 117 generates one decoded block by repeatedly performing the processing from step S112 to step S126.

First, the decoding unit 120 monitors the voltage of the input signal, and upon detecting a drop in the voltage (step S112), starts measuring the low level period T (step S113). The decoding unit 120 continues to simultaneously measure the low level period T and monitor the voltage, and upon detecting a rise in the voltage (step S116), ends the measuring (step S117) The decoding unit 120 determines which of “0” and “1” the bit data is according to the obtained low level period T (step S119).

When the measured low level period T satisfies t1−α≦T≦t1+α(t1−α≦T≦t1+α at step S119), the decoding unit 120 generates and temporarily stores bit data “1” (step S121).

When the measured low level period T satisfies t0−α≦T≦t0+α(t0−α≦T≦t0+α at step S119), the decoding unit 120 generates and temporarily stores bit data “0” (step S122).

When the measured low level period T satisfies neither of t1−α≦T≦t1+α and t0−α≦T≦t0+α (“other” at step S119), the decoding unit 120 temporarily stores bit data “0” (step S124), and generates and stores bit position information showing the position of the data bit in the block (step S126).

When the described processing has been performed with respect to each of the first to ninth bits in the block (step S127), the decoding unit 120 outputs a decoded block composed of the first to eighth bits from among the stored bit data, and bit position information, to the repairing unit 122. In the case of no error bits existing, the decoding unit 120 outputs only the decoded block (step S129).

The repairing unit 122 acquires the decoded block, or the decoded block and bit position information, from the decoding unit 120, and based on the acquired bit position information, counts the number of error bits included in the acquired decoded block (step S130).

If the number of error bits in the acquired decoded block is 0 (“0 bits” at step S131), the repairing unit 122 outputs the acquired decoded block to the determination unit 127 as is, and the determination unit 127 outputs the received decoded block to the control unit 107 as a determined block (step S132). The determination unit 127 then moves the processing to step S148.

When one error bit is included in the decoded block (“1 bit” at step S131), the repairing unit 122 generates a repaired block a in which “0” has been inserted into the error bit shown by the received bit position information, and repaired block b in which “1” has been inserted into the error bit shown by the received bit position information (step S134). The repairing unit 122 outputs the generated repaired block a and repaired block b to the determination unit 127.

The determination unit 127 acquires the repaired block a and the repaired block b from the repairing unit 122, reads the available block table 125 from the storage unit 123, compares the available blocks in the read available block table 125 with the repaired blocks a and b, and searches for one or more available blocks that match the repaired block a and/or the repaired block b (step S136).

When one matching available block is found (“1” at step S141), the determination unit 127 outputs the one of the repaired blocks a and b for which the matching available block was found, to the control unit 107 as a determined block (step S146) and the processing move to step S148.

When 0 or 2 matching available blocks are found (“0 or 2” at step S141), this means that the error is unrepairable, and therefore the determination unit 127 instructs the decoding unit 120 to stop receiving the message.

In accordance with the instruction, the decoding unit 120 stops generating decoded blocks, in other words, stops receiving the message (step S152).

As well as outputting the determined block to the control unit 107, the determination unit 127 instructs the signal output unit 138 to output an ACK signal, and the signal output unit 138 outputs an ACK signal (step S148).

At this time, when the ninth bit, in other words the EOM bit, generated in the repeat of step S111 to step S127 shows that the block is the last block of the message (YES at step S149), the decoding unit 120 ends message reception.

If the EOM bit shows that the block is not the last block of the message (NO at step S149), the decoding unit 120 starts decoding the signal of the section corresponding to the next block.

Transmission Operations

The DVD player 100 transmits a message relating to device control to the television 300 in accordance with a key operation or the like by the user.

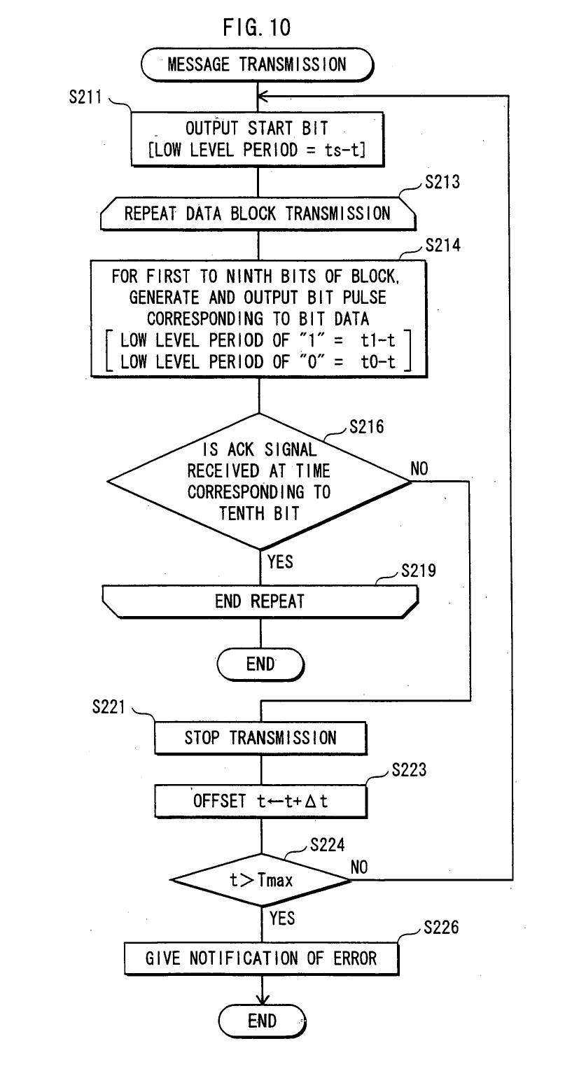

FIG. 10 is a flowchart showing operations for message transmission by the DVD player 100. Referring to FIG. 10, the following describes operations for message transmission.

The control unit 107 generates a message in accordance with the key operation, and instructs the transmission circuit 135 of the device control signal processing unit 104 to transmit the message.

Upon being instructed to output a message, the signal output unit 138 of the transmission circuit 153 first generates and outputs a bit pulse showing a start bit (step S211). At this time, the low level period of the bit pulse generated by the signal output unit 138 is “ts-t”.

Between steps S213 and step S219, the processing of step S214 and step S215 is performed with respect to each block composing the message, and a signal corresponding to the blocks is generated and output.

For each of the first to ninth bits of the block, the signal output unit 138 generates and outputs a bit pulse corresponding to the bit data (step S214). At this time, the low level period of the bit pulse corresponding to the bit data “0” is “t0-t” and the low level period of the bit pulse corresponding to the bit data “1” is “t1-t”.

The result determination unit 139 monitors voltage of the signal wire 192 via the input/output unit 101, and when an ACK signal showing bit data “0” is received at a time corresponding to the tenth bit, in other words, the ACK bit timing (YES at step S216), the result determination unit 139 and the timing adjustment unit 141 do nothing. The signal output unit 138 returns to step S214, and proceeds to the processing of the next data block.

When an ACK signal showing bit data “0” is not received at the time of the tenth bit (NO at step S216), the result determination unit 139 outputs an error signal showing that transmission of the block has failed, to the signal output unit 138 and the timing adjustment unit 141.

The signal output unit 138 stops generating and transmitting signals upon receiving the error signal (step S221).

Upon receiving the error signal, the timing adjustment unit 141 adds the adjustment time Δt stored therein to the stored offset t (step S223). The timing adjustment unit 141 then compares the resultant offset t with the offset threshold value Tmax, and if t≦Tmax (NO at step S224), the timing adjustment unit 141 outputs the offset t to which the adjustment time Δt has been added to the signal output unit 138. The signal output unit 138 returns to step S211, and starts message transmission once again with use of the new offset t.

When t>Tmax (YES at step S224), the timing adjustment unit 141 notifies the control unit 107 that occurrence of an error cannot be avoided by adjustment of the offset t.

The control unit 107 receives the notification from the timing adjustment unit 141, and notifies the user that a communication error has occurred, by, for instance, causing the indicator 106 to flash (step S226).

1.3 Television 300

As shown in FIG. 1, the television 300 is composed of an input/output unit 301, a tuner 302, a device control signal processing unit 304, a playback processing unit 306, a control unit 307, and an input unit 308.

The following describes the compositional elements of the television 300. Note, however, that the structure and operations of the input/output unit 301 and the device control signal processing unit 304 are the same as the input/output unit 101 and the device control signal processing unit 104 of the DVD player 100, and therefore a description of these units is omitted.

(1) Antenna 303 and Tuner 302

The tuner 302 is connected to the antenna 303 which is provided on the outside of the television 300. From a broadcast wave received by the antenna 303, the tuner 302 extracts and demodulates only bandwidth corresponding to a channel selected according to a user operation, and generates broadcast program content that includes video and audio, and outputs the broadcast program content to the playback processing unit 306.

(2) Input Unit 308

The input unit 308 includes various buttons such as a channel selection button, a menu button, an OK button, and a volume button, and may also has an infrared communication function and receive remote control operations from the user. The input unit 308 outputs operation instruction information showing a button operation or a remote control operation by the user to the control unit 307.

(3) Control Unit 307

The control unit 307 controls operations of the units of the television 300 based on operation instruction information output from the input unit 308 and messages acquired via the device control signal processing unit 304.

The control unit 307 controls the device control signal processing unit 304 in the same was as the control unit 107 of the DVD player 100, and therefore the description is not repeated here.

(4) Playback Processing Unit 306

The playback processing unit 306 is composed of a speaker and a liquid crystal display, and performs playback of broadcast program content output from the tuner 302 and playback of content output from the DVD player 100 via the input/output unit 301.

1.4 Conclusion

As has been described, the device control signal processing unit provided in each of the devices in the transmission/reception system of the first embodiment stores an available block table in advance, and if a pulse signal that cannot be determined as “0” or “1” is received when receiving a message relating to device control, the device control signal processing unit generates repaired blocks a and b in which “0” and “1”, respectively, have been inserted into the error bit corresponding to the pulse signal. The device control signal processing unit compares the generated repaired blocks a and b with available blocks in the available block table, and when it detects an available block matching one of the repaired blocks a and b, employs the one of the repaired blocks as a determined block.

With this structure, even if information for error correction is not included in a message transmitted between devices, a determined block in which the error bit has been corrected can be generated accurately.

Furthermore, when transmitting a message, the low level period of each bit pulse can be shortened when it is detected that an error has occurred. As described in the Description of the Related Art, one example of the cause of an error occurring on the reception side is the lengthening of the low level period recognized on the reception side due to dispersion of the waveform during communication.

Therefore, as in the present embodiment, transmitting bit pulses in which the low level period has been shortened in advance reduces the likeliness of an error occurring.

### 2. Second Embodiment

The following describes a transmission/reception system of the second embodiment of the present invention. Note that the following description omits aspects that are the same as the first embodiment, and focuses on the features of the second embodiment.

2.1 Overviews

The transmission/reception system in the second embodiment is structured, similarly to the first embodiment, from a DVD player and a television connected by a cable that complies with HDMI standard.

When a message relating to device control is transmitted and received between the devices, the reception-side device measures the low level period of a received bit pulse, and generates bit data “0” or “1” in accordance with the measured low level period.

When unable to distinguish which of “0” and “1” a received bit pulse is, the reception-side device inserts “0” or “1” into the error bit corresponding to the bit pulse in accordance with the low level period of the bit pulse.

Note that other than the reception circuit, the function units of the television are the same as those of the first embodiment, and the structure and operations of the reception circuit are the same as a reception circuit 228 described below. Therefore, a description of the television is omitted.

2.2 DVD Player

The DVD player of the present embodiment is composed of an input/output unit, a drive unit, a decryption unit, a device control signal processing unit, an indicator, a control unit and an input unit. The device control signal processing unit is composed of a transmission circuit and a reception circuit.

The compositional elements other than the reception circuit are the same as the input/output unit 101, the drive unit 102, the decryption unit 103, the transmission circuit 135, the indicator 106, the control unit 107 and the input unit 108 in the DVD player 100 of the first embodiment, and therefore a description is omitted here. The following describes the reception circuit 228 that is the feature of the present embodiment.

(1) Reception Circuit 228

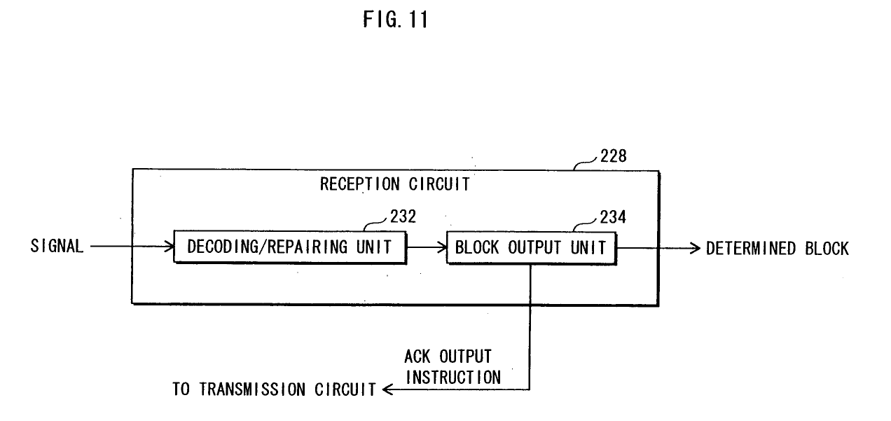

FIG. 11 is a function block diagram showing the functional structure of the reception circuit 228 of the present embodiment. As shown in FIG. 11, the reception circuit 228 is composed of a decoding/repairing unit 232 and a block output unit 234.

(1-a) Decoding/Repairing Unit 232

The decoding/repairing unit 232 monitors the voltage of the signal wire via the input/output unit in the same way as the decoding unit 120 of the first embodiment, and detects a bit pulse corresponding to the start bit.

Upon detecting the start bit, the decoding/repairing unit 232 measures the low level period T of each subsequent bit pulse. The decoding/repairing unit 120 generates bit data “1” or “0” in accordance with the measured low level period T, and then outputs the generated bit data successively to the block output unit 234.

When unable to distinguish which of “1” and “0” the bit data corresponding to a received bit pulse is based on the measured low level period T, the decoding/repairing unit 232 inserts “1” or “0” into the bit corresponding to the bit pulse in accordance with the measured low level period, and outputs the repaired bit data to the block output unit 234.

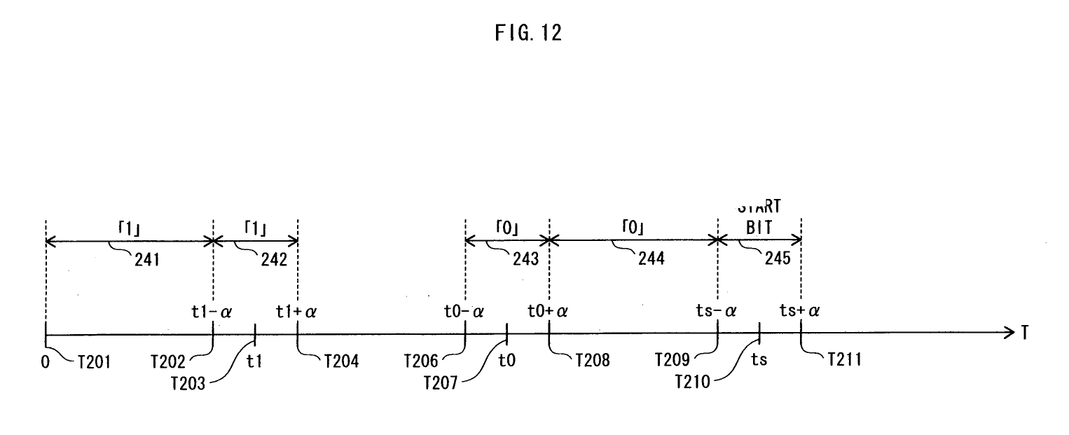

FIG. 12 shows the correspondence between the measured low level period T and the bit data output by the decoding/repairing unit 232. The horizontal axis represents the low level period T.

The low level periods T 203 “t1”, T 207 “t0” and T 210 “ts” are low level periods corresponding to bit data “1” and “0” and the start bit, respectively, defined by the HDMI standard.

As already described, an area 242 that is a low level period T202 “t1−α” to T204 “t1+α”, an area 243 that is a low level period T206 “t0−α” to T208 “t0+α”, and an area 245 that is a low level period T209 “ts−α” to T211 “ts+α” are areas determined to be bit data “1”, bit data “0”, and a start bit, respectively. After detecting the start bit, if the measured low level period is included in the area 242 or 243, the decoding/repairing unit 232 outputs the bit data “1” or “0”, respectively, to the block output unit 234.

The area 241 that is a low level period T 201 “0” to T 202 “t1−α” is an area into which bit data “1” has been inserted, and the area 245 that is a low level period T 208 “t0+α” to T 209 “t1α” is an area into which bit data “0” has been inserted.

If the low level period T of a bit pulse corresponding to an error bit is included in the area 241 or 244, the decoding/repairing unit 232 inserts bit data “1” or “0”, respectively, into the error bit.

If the low level period T of a bit pulse corresponding to an error bit is not included in the area 241 or 244, the decoding/repairing unit 232 determines that an unrepairable error has occurred, and stops receiving the message.

(1-b) Block Output Unit 234

The block output unit 234 acquires the bit data subsequent to the start bit from the decoding/repairing unit 232 one bit at a time, and stores the acquired bit data temporarily. Upon acquiring the bit data of each of the first to ninth bits of each block, the block output unit 234 outputs an instruction to output an ACK signal to the transmission circuit, and outputs a determined block composed of the bit data of the stored first to eighth bits.

(2) Operations for Message Reception

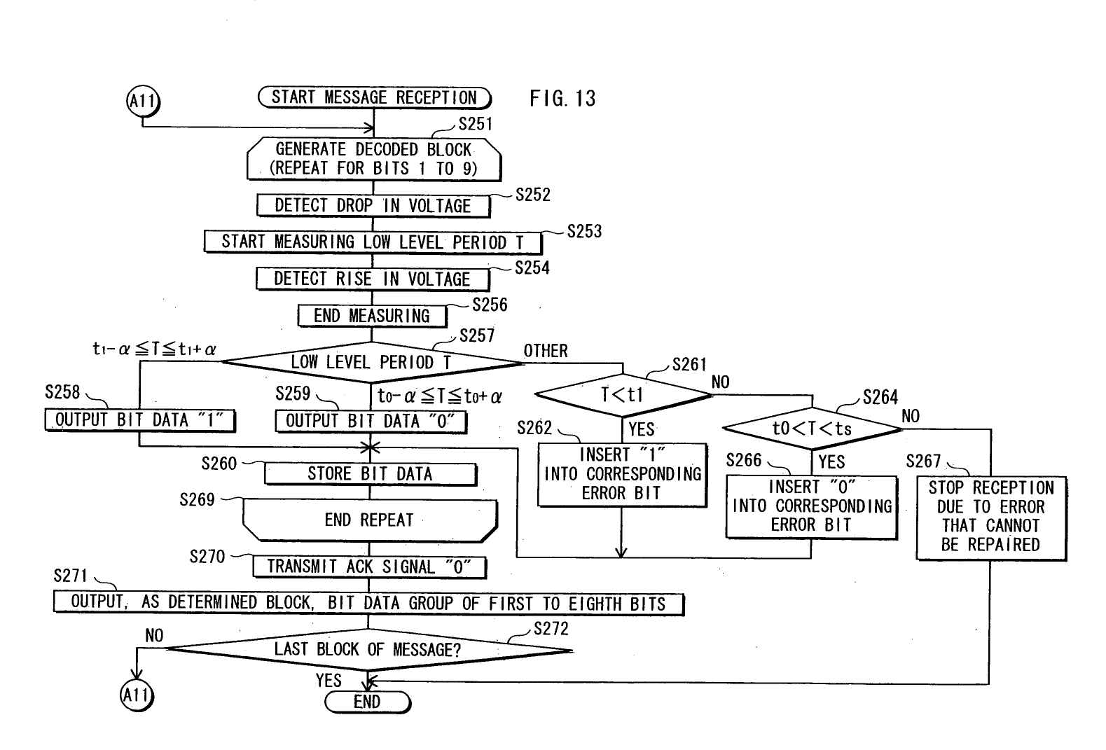

FIG. 13 is a flowchart showing operations for message reception by the DVD player of the second embodiment. The following describes operation for message reception with reference to FIG. 13.

Upon the decoding/repairing unit 232 detecting a start bit, the device control signal processing unit starts receiving message.

At step S251 to step S269, the decoding/repairing unit 232 and the output unit 234 perform the processing of step S252 to step S266 for each bit pulse, in order to generate a determined block.

The decoding/repairing unit 232 detects a drop in voltage of the signal line (start of a bit pulse) via the input/output unit (step S252), and starts measuring the low level period T (step S253). The decoding/repairing unit 232 continues to monitor the voltage while simultaneously measuring time, and upon detecting a rise in voltage (step S254), ends the measuring of the low level period T (step S256).

When the measured low level period satisfies t1−α≦T≦t1+α(t1−α≦T≦t1+α at step S257), the decoding/repairing unit 232 outputs bit data “1” to the block output unit 234 (step S258).

When the measured low level-period satisfies t0−α≦T≦t0+α(t0−α≦T≦t0+α at step S257), the decoding/repairing unit 232 outputs bit data “0” to the block output unit 234 (step S259).

When the measured low level period satisfies neither of t1−α≦T≦t1+α and t0−α≦T≦t0+α (“other” at step S257), the decoding/repairing unit 232 further compares the measured low level period T with t1 (step S261), and if T<t1 (YES at step S261), the decoding/repairing unit 232 inserts the bit data “1” into the error bit corresponding to the bit pulse (step S262). The decoding/repairing unit 232 then outputs the repaired bit data “1” to the block output unit 234.

If T<t1 is hot satisfied (NO at step S261), the decoding/repairing unit 232 next compares the measured low level period with standard values t0 and ts (step S264). If t0<T<ts (YES at step S264), the decoding/repairing unit 232 inserts “0” into the error bit corresponding to the bit pulse (step S266), and outputs the repaired bit data “0” to the block output unit 234.

The block output unit 234 receives the bit data from the decoding/repairing unit 232, and temporarily stores the received bit data (step S260).

When the repeated processing has ended for the bit pulses corresponding to the first to ninth bits (step S269), the block output unit 234 instructs the transmission circuit to output an ACK signal of bit data “0”.

In accordance with the instruction from the block output unit 234, the signal output unit of the transmission circuit outputs an ACK signal of bit data “0” at the ACK bit timing (step S270).

In addition to the ACK signal output instruction, the block output unit 234 outputs a bit data group composed of the first to eighth bits of the stored bit data of the first to ninth bits, to the control unit as a determined block (step S271).

At this time, if the ninth bit, in other words, the EOM bit, does not show that the block is the last block (NO at step S272), the processing returns to step S251, and the processing of the next block starts.

If the EOM bit shows that the block is the last block of the message (YES at step S272), reception of the message ends.

Furthermore, at step S264, if the measured low level period does not satisfy t0<T<ts (NO at step S264), the decoding/repairing unit 232 determines that an unrepairable error has occurred, and stores signal reception and decoding (step S267). The device control signal processing unit ends message reception operations without transmitting an ACK signal.

2.3 Conclusion

As has been described, when the reception circuit 228 of the DVD player of the second embodiment receives a bit pulse that cannot be determined as being “0” or “1”, the bit data is repaired in accordance with the low level period T of the bit pulse.

Specifically, when the measured low level period does not reach the low level period t1 of bit data “1” defined by the HDMI standard, the reception circuit inserts “1” into the error bit corresponding to the bit pulse.

When the low level period T is a value between the low level period t0 of the bit data “0” defined by the HDMI standard and the low level period ts of a start bit, bit data “0” is inserted into the error bit corresponding to the bit pulse.

In this way, since determination of whether a bit is an error bit, and repairing, are performed one bit at a time, the reception circuit of the present embodiment is able to deal with a situation in which a plurality of error bits occur in one block.

### 3. Third Embodiment

The following describes a third embodiment of the present invention with reference to the drawings. The transmission/reception system of the third embodiment is, similarly to the first embodiment, composed of a DVD player, a television and the like connected by a cable that complies with the HDMI standard. Note that the following describes only the features of the present embodiment, and omits aspects that are the same as the first embodiment.

3.1 Overview

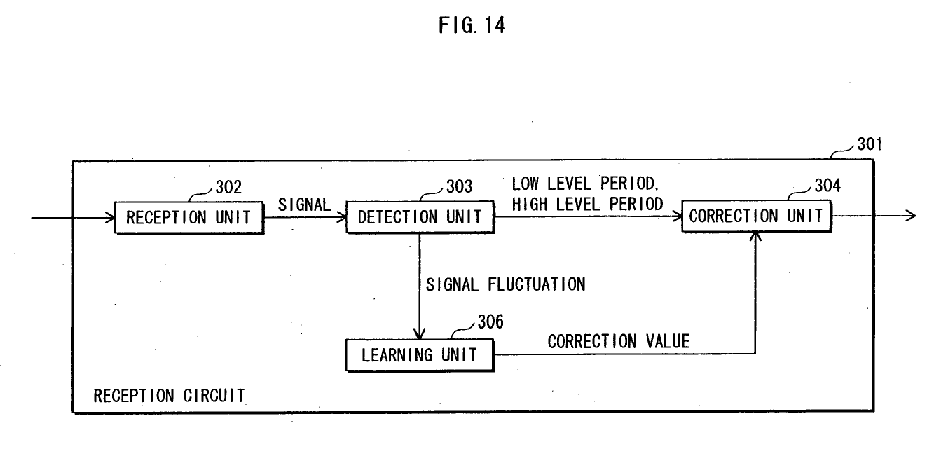

FIG. 14 is a block diagram showing a reception circuit included in a device in the transmission/reception system of the third embodiment. In the present embodiment, the reception circuit compares a low level period and a high level period of a signal received from an external device with a low level period and a high level period defined by the HDMI standard, and calculates a difference therebetween. The reception circuit calculates a correction value from the calculated difference, and when a signal is subsequently received from the external device, corrects the low level period and the high level period of the received signal using the correction value.

Furthermore, although not illustrated, the device is equipped with a transmission circuit the same as that of the first embodiment, and has a function of performing transmission of various signals such as an ACK bit according to an instruction from a determination unit or a control unit.

3.2 Structure

As shown in FIG. 14, the reception circuit 301 is composed of a reception unit 302, a detection unit 303, a learning unit 306, and a correction unit 304. Furthermore, although not specifically illustrated, the reception circuit 301 includes the decoding unit described in the first embodiment. The decoding unit decodes a corrected signal, and generates a determined block consisting of data bits “1” and “0”, and outputs the determined block to the control unit. Alternatively, the correction unit 304 may include the function of the decoding unit described in the first embodiment, and may generate a determined block from a corrected signal and output the determined block to the control unit.

(1) Reception Unit 302

The reception unit 302 receives a signal from an external device via the input/output unit described in the first embodiment, and outputs the received signal to the detection unit 303.

(2) Detection Unit 303

The detection unit 303 stores in advance test data (start bit+8 bits) received in order to determine a correction value ΔT described below.

The detection unit 303 measures the low level period and the high level period of a start bit signal received by the reception unit 302 (or measures either the low level period or the high level period), and calculates a difference between the measured values and standard values of the low level period and the high level period of the measured value. In the following description, a value obtained by subtracting the low level period standard value from the measured low level period of the start bit signal is notated as a difference ΔTs.

The detection unit 303 also similarly calculates a difference for the bit data of each of the eight bits after the start bit. These differences ΔT0 to ΔT7 are calculated by subtracting the standard value of the data bit of corresponding test data from the measured value of the low level period of the bit data of the respective bit.

The detection unit 308 outputs the calculated ΔTs and ΔT0 to ΔT7 to the learning unit 306.

Furthermore, after calculating the differences as described, the detection unit 303 measures a low level period and a high level period of the signal received from the reception unit 302, and successively outputs the measured low level period and high level period to the correction unit 304.

(3) Learning Unit 306

The learning unit 306 receives ΔTs and ΔT0 to ΔT7 from the detection unit 303, and calculates a average value of the received differences. The calculated average value is referred to as a correction value ΔT in the description below.

Note that although the learning unit 306 is described here as simply making the average value of ΔTs and ΔT0 to ΔT7 to be the correction value ΔT, ΔTs and ΔT0 to ΔT7 may each be weighted, and the correction value ΔT calculated therefrom.

(4) Correction Unit 304

The correction unit 304 receives and stores the correction value ΔT from the learning unit 306. The correction unit 304 also successively receives the low level period and the high level period from the detection unit 303.

The correction unit 304 corrects each received low level period and high level period with ΔT, and outputs the resultant signal to the decoding unit (not illustrated).

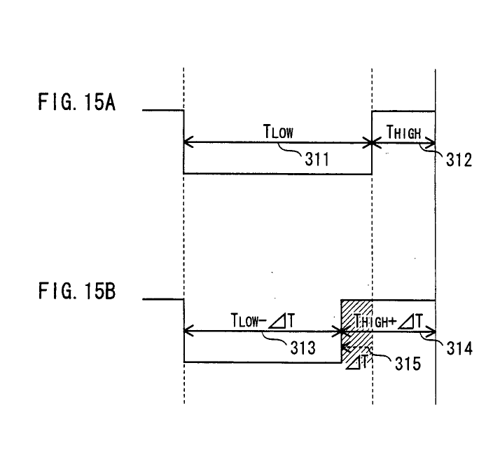

Referring to FIGS. 15A and 15B, a description is now given of the correction by the correction unit 304. FIG. 15A shows the state of a signal received by the reception circuit before correction. FIG. 15B shows the signal corrected using the correction value ΔT.

The correction unit 304 receives a low level period 311 and then a high level period 312 as shown in FIG. 15A from the detection unit 303. Upon receiving these, the correction unit 303 subtracts the correction value ΔT from the received low level period 311 “Tlow”, to calculate a corrected low level period 313 “Tlow<−Tlow−ΔT”, and outputs the corrected low level period 313. The correction unit 303 then adds the correction value ΔT to the received high level period 312 “Thigh”, to calculate a corrected high level period 314 “Thigh+ΔT”, and outputs the corrected high level period 314.

3.3 Operations

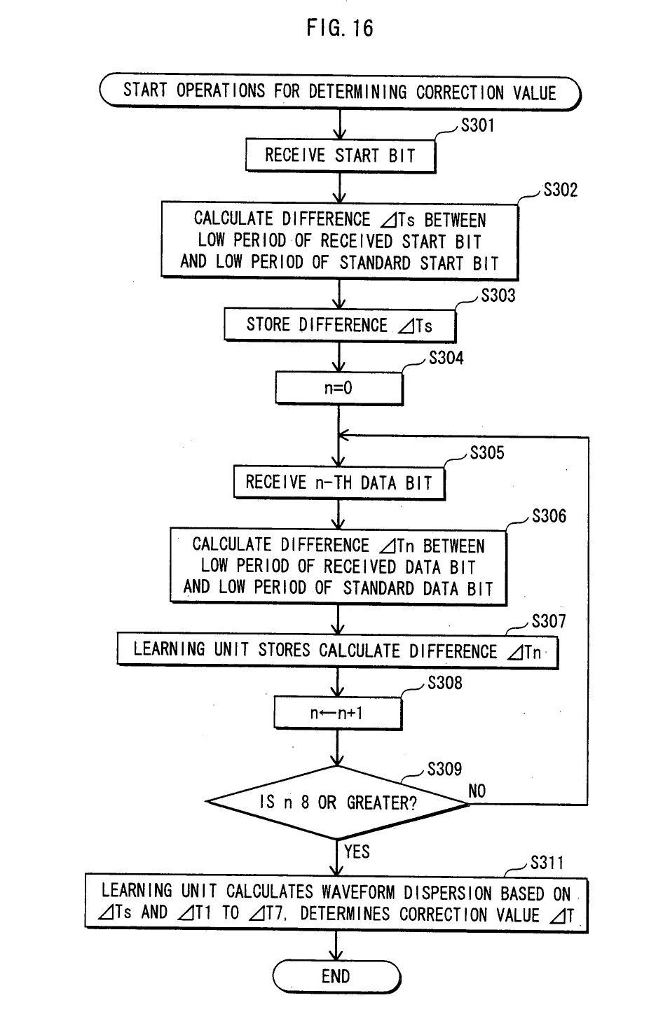

Referring to the flowchart in FIG. 16, the following describes operations of the reception circuit 301 having the described structure.

Operations for Determining the Correction Value

The following processing for determining the correction value ΔT may be performed at any time. As one example, the processing for determining the correction value ΔT may start when the power of the device is turned on and be triggered by test data being sent from a predetermined other device. Alternatively, regular requests for test data may be made to a predetermined device, and the processing for determining the correction value ΔT may start as a result of the requested test data being received.

The reception unit 301 receives a start bit signal (step S301).

The detection unit 303 measures the low level period of the start bit, and calculates a difference ΔTs from a standard low level period (step S302). The detection unit 303 then outputs the calculated difference ΔTs to the learning unit 306.

The learning unit 306 stores the difference ΔTs (step S303).

The reception unit 302 initializes a variable n that counts the received bit data to “0” (step S304).

The reception unit 302 receives the n-th bit data (step S302), and outputs the received bit data to the detection unit 303.

The detection unit 303 measures the low level period of the n-th bit data, and calculates the difference ΔTn between the standard low level period (step S305).

The learning unit 306 stores ΔTn (step S307), and the reception unit 302 increments the variable n (step S308).

If the incremented variable n is lower than 8 (NO at step S309), the processing returns to step S305, and steps S305 to S309 are repeated until n≧8.

If n≧8 (YES at step S309), the learning unit 311 calculates the average value ΔT of ΔTS and ΔT0 to ΔT7, and the correction unit 304 stores the average value ΔT as the correction value ΔT (step S311).

Note that in the third embodiment, although the correction value ΔT is determined according to the average of the start bit and the 0th data bit to the 7th data bit, a separate correction value for each of a start bit, a bit having a value 0 and a bit having a value 1 may be calculated instead, and the correction unit 304 may use these three correction values accordingly.

Message Reception Operations After Determining a Correction Value

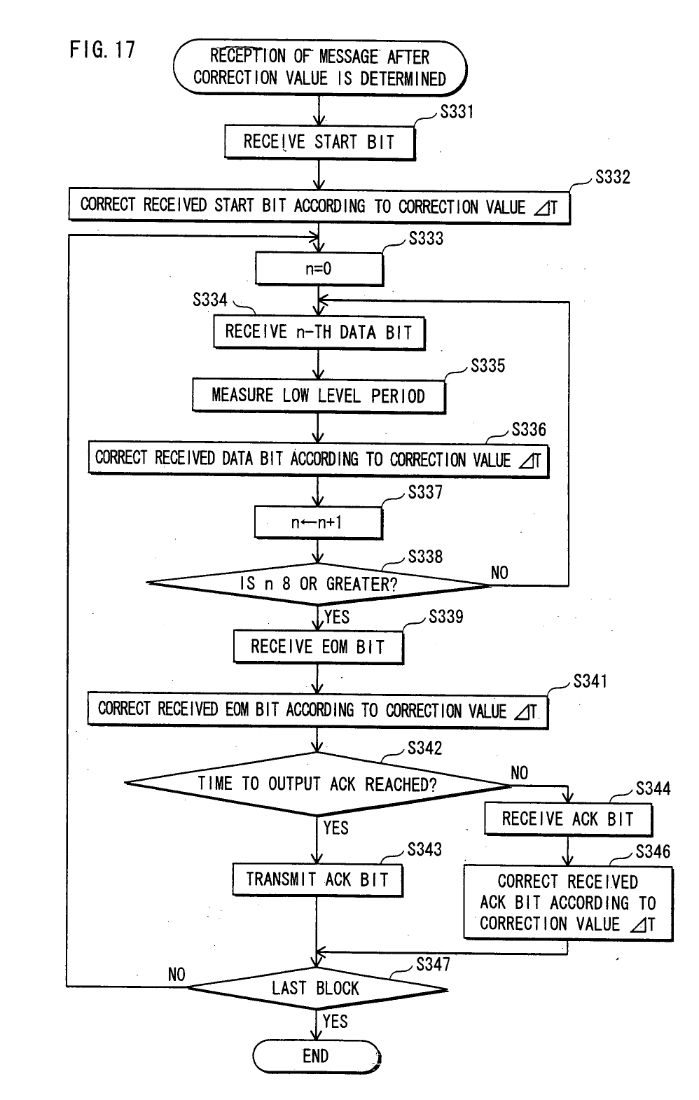

Referring to the block diagram in FIG. 13 and to FIG. 17, the following describes operations by the reception unit 301 after the correction value ΔT has been determined according to the operations described above.

The reception unit 302 receives a start bit (step S331), and the detection unit 303 measures the low level period and high level period of the received start bit, and outputs the measured low level period and high level period to the correction unit 304.

The correction unit 304 corrects the received low level period and high level period of the start bit with the correction value ΔT, and outputs the corrected low level period and high level period to the decoding unit (not illustrated, step S332).

The reception unit 302 initializes the variable n that counts the data bits to 0 (step S333).

The reception unit 302 receives the n-th data bit (step S334), and the detection unit 303 measures the low level period and the high level period of the received data bit, and outputs the measured low level period and high level period, to the correction unit 304 (step S335).

The correction unit 304 corrects the received n-th data bit with the correction value ΔT (step S336), and the reception unit 302 increments the variable n (step S337). If the variable n is lower than 8 (NO at step S338), the processing returns to step S334, and steps S334 to S338 are repeated until variable n=8.

When variable n≧8 (YES at step S338), the reception unit 302 then receives an EOM bit, and the detection unit 303 measures the low level period and the high level period of the received EOM bit (step S339). The correction unit 304 corrects the measured EOM bit with the correction value ΔT (step S341). Next, if the output timing of the ACK bit is reached (step S347), the transmission circuit (see the first embodiment) transmits an ACK bit (step S343).

If the current timing is not the ACK response timing (NO at step S342), the reception unit 302 receives an ACK signal from the counterpart device, and the detection unit 303 measures the low level period and the high level period (step S344). The correction unit 304 corrects the ACK bit with the correction value ΔT (step S346).

At step S341, if the corrected EOM bit does not show that the block is the last block (NO at step S347), the processing returns to step S333, and the processing at steps S333 to S347 is performed for subsequent data blocks.

If the EOM bit shows that the block is the last block (YES at step S347), operations for receiving the message after the determination of the correction value end.

Note that although the reception unit 302 is described as counting the number of received data bits, the received data bits may instead be counted by the detection unit 303 or the correction unit 304.

### 4. Other Modifications

Although the present invention has been described based on, but is not limited to, the first to third embodiments. The following cases are included in the present invention.

(1) In the first embodiment, the storage unit 123 of the reception circuit 117 stores only one available block table. However, the storage unit 123 may store a plurality of available block tables as follows.

As described with reference to FIG. 2A, the message 1 includes a plurality of blocks, the data block after the header block includes a command, and the subsequent data blocks include data used in execution of the command.

The storage unit 123 stores one command table and a plurality of data tables. The command table is composed of 8-bit available commands. Each data table corresponds to one of the available commands. Each data table includes a plurality of available blocks, and is data that use used in executing the corresponding available command.

When a repaired block corresponding to the data block directly after the header block is received, the determination unit 127 reads the command table from the storage unit 123, and determines a block with use of the read command table.

Next, the determination unit 127 reads a data table corresponding to the block determined using the command table (in other words, the command included in the data block directly after the header block), from the storage unit 123. Note that when the decoded block corresponding to the data block directly after the header block does not include an error bit, the determination unit 127 reads the data table corresponding to the decoded block.

The determination unit 127 then uses the read data table to determine a block with respect to the subsequent blocks.

The storage unit 123 may store an address table composed of address blocks, each of which is a concatenation of the address of an external device connected via a cable (4 bits) and the address of the DVD player itself (four bits). For instance, if a television having an address “0000” and a set top box having an address “0001” are connected via the cable, and the address of the DVD player is “0010”, the address table includes address blocks “00000010” and “00010010”. The determination unit 127 may determine a block for the block directly after the start bit (in other words, the header block) using the address table.

(2) Furthermore, the storage unit 123 may store a plurality of available block tables corresponding to the status of the reception-side device and the device that transmitted the data, and the determination unit may perform repairing using the most appropriate available block table in the available block table.

The following describes this modification example with reference to the drawings.

(2-1) Structure

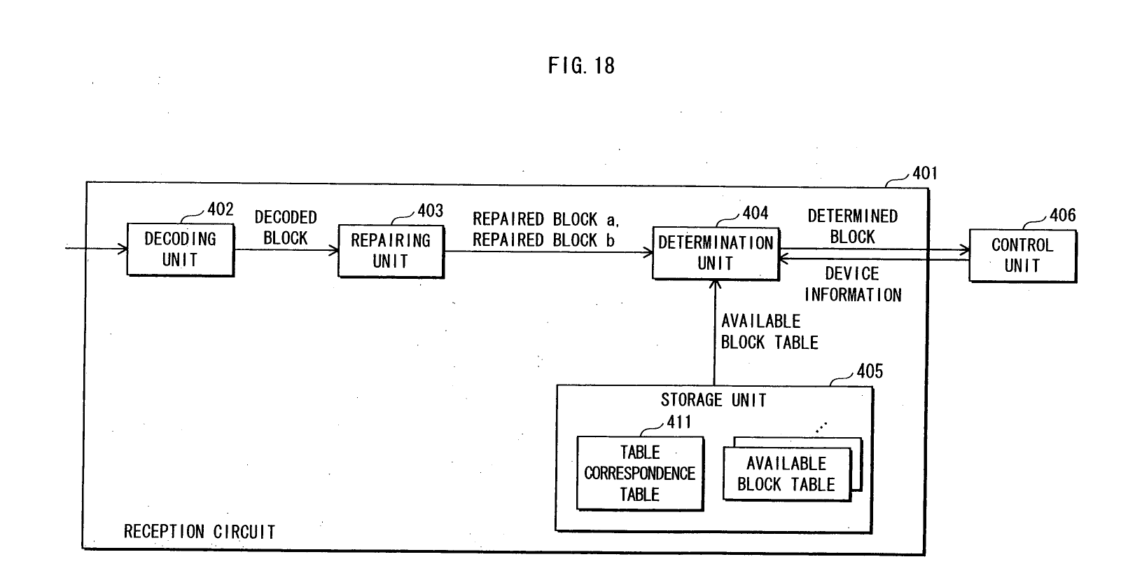

This modification example (2) is described with reference to the drawings. FIG. 18 is a block diagram showing a reception circuit 401 and a control unit 406 mounted in a device in the system.

As shown in FIG. 18, the reception circuit 401 includes a decoding unit 402, a repairing unit 403, a determination unit 404, and a storage unit 405. The decoding unit 402 and the repairing unit 403 are the same as the decoding unit 120 and the repairing unit 122 in the first embodiment, and therefore a description thereof is omitted here.

(2-1-1) Storage Unit 405

The storage unit 405 storage a plurality of available block tables, and in the present example, manages the available block tables using a table correspondence table. The storage unit 405 also stores the address table described in modification example (1) (not illustrated).

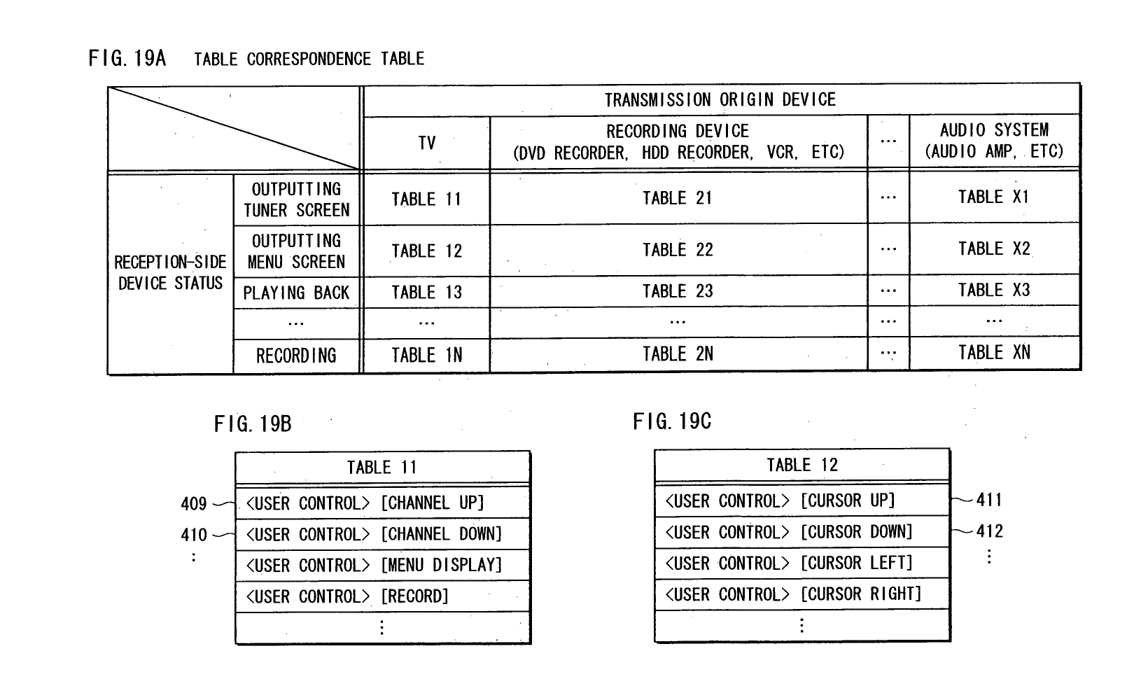

FIGS. 19A to 19C show examples of the table correspondence table and available block tables managed by the table correspondence table.

Here, the device equipped with the reception circuit is described being a DVD player as one example.

The names of the devices in the system (transmission-origin devices) are listed in the horizontal direction in FIG. 19A, and statuses of the DVD player are listed in the vertical direction. Furthermore, in each field where one of the transmission-origin devices and the statuses of the reception device intersect is the name of the most appropriate available block table (table 11, 12, . . . 21, 22, . . . XN). Note that for convenience of description, the table correspondence table in FIG. 19A is composed of transmission-origin names, reception device states, and available block table names. However, instead of the names of the transmission-origin devices, the table correspondence table may be composed of transmission-origin device addresses, bit strings showing statuses of the reception-side device, and addresses of available block tables.

For instance, the table correspondence table shows that if the status of the reception-side device is “outputting tuner screen” when a message is received from the transmission-origin device “TV”, the most appropriate available block table is “table 11”.

As a further example, the table correspondence table shows that if the status of the reception-side device is “playing back” when a message is received from the transmission-origin device “recording device”, the most appropriate available block table is “table 23”.

FIGS. 19B and 19C show specific examples of available block tables “table 11” and “table 12” managed by the table correspondence table.

The “table 11” shown in FIG. 19B is composed of a plurality of available blocks 409, 410 . . . . Each available block is an 8-bit long bit string as shown in FIG. 5, and the meaning of each available block is shown here. For instance, available blocks 409, 410, . . . are blocks composing messages that may be received from the transmission-side device “TV” while the reception-side device “DVD player” is outputting a tuner screen. More specifically, the available block 409 is an 8-bit long bit string showing that a “channel up” operation has been performed by the user. The available block 410 is an 8-bit long bit string showing that a “channel down” operation has been performed by the user.

The “table 12” shown in FIG. 19C is composed of available blocks 411, 412, . . . , which are available blocks composing messages that may be received from the transmission-side device “TV” while the reception-side device “DVD player” is outputting a menu screen. For instance, the available block 411 shows that the user has performed an operation to move a cursor upward.

(2-1-2) Determination Unit 404

The determination unit 404 stores the address of the DVD player.

The determination unit 404 receives a start bit via the input/output unit (see first embodiment), the decoding unit 402 and the repairing unit 403, and then receives the first eight blocks of the header block, and using the address table as necessary, determines the address of the transmission destination.

Next, the determination unit 404 compares the determined transmission-destination address and the stored address of the DVD player, and does nothing if the two are different.

If the two match, or if the transmission-destination address is a broadcast address, the determination unit 404 specifies the transmission-origin device of the message based on the transmission-origin address in the header block.

The determination unit 404 then acquires information showing the current status of the DVD player from the control unit 406. Next, using the table correspondence table, the determination unit 404 selects an available block table matching the acquired DVD player status and the transmission-origin device, and reads the selected available block table from the storage unit 405.

The determination unit 404 then determines a block using the read available block table in the same way as in the first embodiment, and outputs the determined block to the control unit 406.

Note that the information showing the status of the device may be constantly output from the control unit 406, or may be acquired when necessary by the determination unit 404 making a request to the control unit 406.

(2-1-3) Control Unit 406

The control unit 406 is a function unit that controls operations of the units in the DVD player based on user operations.

The control unit 406 outputs information showing the current status of the DVD player to the determination unit 404 of the reception circuit 401.

(2-2) Operations

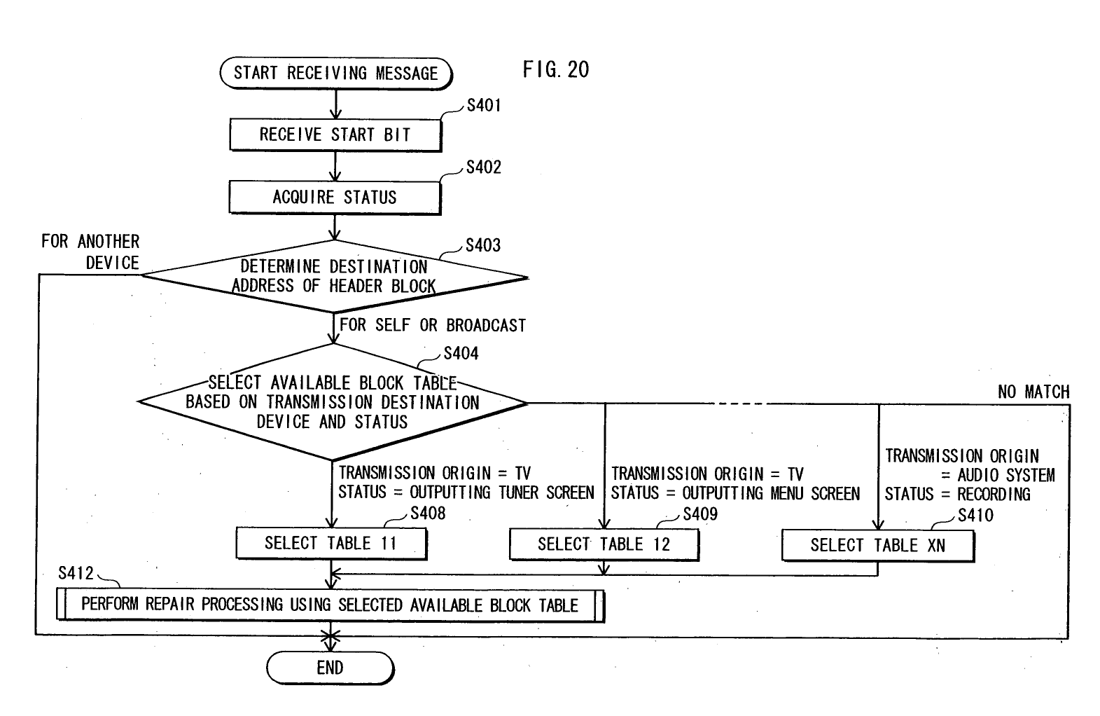

FIG. 20 is a flowchart showing message reception operations by the DVD player of the present embodiment. Referring to FIG. 20, the following describes operations by the DVD player when receiving a message. Note that only operations characteristic to the present modification example are described here, and a description of operations when the decoding unit is unable to decode normally (in other words, when repairing is necessary) and operations when repairing fails is omitted. See FIG. 8 to FIG. 9 for details of these cases.

Upon receiving a start bit via the decoding unit 402 and so on (step S401), the determination unit 404 acquires information showing the current status of the DVD player from the control unit 406 (step S402).

The determination unit 404 then detects the destination address based on the header block received after the start bit, and specifies the destination device (step S403). When the destination is another device in the system (“for another device” at step S403), the operations for message reception end.

When the destination device is the DVD player itself or in the case of a broadcast (“for self or broadcast” at step S403), the determination unit 404 selects the most appropriate available block table by referring to the table correspondence table, based on the transmission-origin device of the message and the current status acquired from the control unit (step S404). For instance, if the transmission-origin device is “TV” and the status of the DVD player is “outputting tuner screen” (“transmission origin=TV, status=outputting tuner screen” at step S404), the determination unit 404 selects “table 11” as the available block table. As another example, when the transmission-origin device is “TV” and the status of the DVD player is “outputting tuner screen” (“transmission-origin=TV, status=outputting menu screen” at step S404), the determination unit selects “table 12” as the available block table (step S409). Similarly, when the transmission-origin device is “audio system” and the status of the DVD player is “recording”, the determination unit 404 selects “table XN” (step S410).

Here, when an available block table that matches the combination of the transmission-origin device and the status of the DVD player does not exist (“no match” at step S404), the processing for message reception ends.

The determination unit 404 then performs repair processing using the selected available block table (step S412).

(2-3) Conclusion

If the type of the reception-side device, the status of the reception-side device at the time of reception, and the transmission-origin of the message can be determined, candidates for the blocks that compose a message are inevitably limited.

According to the present modification example, can perform repair processing accurately and promptly by using the available block tables appropriately.

(3) In the first embodiment, when unable to determine whether a bit pulse is “1” or “0” when generating a decoded block, the decoding unit 120 generates a data block that includes bit data “0” corresponding to the bit pulse, further generates bit position information showing the position of the error bit, and outputs the decoded block and the bit position information to the repairing unit 122. However, the present invention is not limited to this structure, and the reception circuit 117 may include a decoding/repairing unit that has the functions of both the decoding unit 120 and the repairing unit 122, and does not generate a decoded block.

After detecting a start bit, the decoding/repairing unit decodes section of a signal corresponding to one block, and generates a repaired block. In more detail, in the same way as the decoding unit 120, the decoding/repairing unit generates bit data “1” or “0” for each bit pulse in the signal section corresponding to a block, in accordance with the low level period of the bit pulse. The decoding/repairing unit temporarily stores each generated bit data. Here, for instance, if the bit pulse corresponding to the third bit is unable to be distinguished as “1” or “0”, the decoding/repairing unit copies the stored bit data of the first and second bits, and generates a bit string a in which “0” has been inserted into the third bit, a bit string b in which “1” has been inserted into the third bit.

Subsequently, the decoding/repairing unit then decodes the bit pulses corresponding to the fourth to eighth bits to each of the generated bit string a and bit string b. Having stored the bit data of the eighth bit, the decoding/repairing unit outputs the 8-bit long bit string a and the 8-bit long bit string b as the repaired blocks a and b, respectively, to the determination unit 127.

Note that when a bit pulse that is undistinguishable as “1” or “0” is included in the bit pulses corresponding to the fourth to eighth bit, the decoding/repairing unit determines that an unrepairable error has occurred, and stops generating the repaired blocks.

(4) In described embodiments, an RZ (return to zero) method is used to express the digital signal, and bit data “1” or “0” is generated in accordance with how long the voltage is maintained at low level. However, the signal is not limited to being expressed using the RZ method, and may be expressed using another method. In particular, in the case of the reception circuit 117 of the first embodiment, repairing can be performed accurately if the storage unit 123 has an available block table that conforms with the HDMI standard, and therefore any method may be employed to express the digital signal. In this case, the decoding unit includes a decoding function corresponding to the method employed.

(5) Each described apparatus is, specifically, a computer system composed of a microprocessor, a ROM, a RAM, a hard disk unit, a display unit, a keyboard, a mouse, and the like. Computer programs are stored in the ROM, the RAM, and the hard disk unit. Each apparatus achieves predetermined functions by the microprocessor operating according to the computer programs. Each computer program is composed of a plurality of instruction codes showing instructions with respect to a computer in order to have predetermined functions achieved.

(6) All or part of the compositional elements of each apparatus may be composed of one system LSI (Large Scale Integrated circuit). The system LSI is a super-multifunctional LSI on which a plurality of compositional units are manufactured integrated on one chip, and is specifically a computer system that includes a microprocessor, a ROM, a RAM, or the like. A computer program is stored in the RAM. The system LSI achieves its functions by the microprocessor operating according to the computer program.

(7) The present invention may be methods shown by the above. Furthermore, the methods may be a computer program realized by a computer, and may be a digital signal of the computer program.

Furthermore, the present invention may be a computer-readable recording medium such as a flexible disk, a hard disk, a CD-ROM, an MO, a DVD, a DVD-ROM, a DVD-RAM, a BD (Blu-ray Disc) or a semiconductor memory, that stores the computer program or the digital signal. Furthermore, the present invention may be the computer program or the digital signal recorded on any of the aforementioned recording media.

Furthermore, the present invention may be the computer program or the digital signal transmitted on a electric communication network, a wireless or wired communication network, a network of which the Internet is representative, or a data broadcast.

Furthermore, the present invention may be a computer system that includes a microprocessor and a memory, the memory storing the computer program, and the microprocessor operating according to the computer program.

Furthermore, by transferring the program or the digital signal to the recording medium, or by transferring the program or the digital signal via a network or the like, the program or the digital signal may be executed by another independent computer system.

(8) Furthermore, the present invention also includes a case in which the all of the function blocks of the DVD player 100 and the television 300 of the described embodiments as shown in FIG. 1 are realized as an LSI which is an integrated circuit. Furthermore, a case in which not all but some of the function blocks are realized as an LSI is also included in the present invention. Here, the LSI may be an IC, a system LSI, a super LSI, or ultra LSI, depending on the degree of integration.

Furthermore, the integration of circuits is not limited to being realized with LSI, but may be realized with a special-purpose circuit or a general-use processor. Alternatively, the integration may be realized with use of a FPGA (field programmable gate array) that is programmable after manufacturing of the LSI, or a re-configurable processor that enables re-configuration of the connection and settings of circuit cells in the LSI.

Furthermore, if technology for an integrated circuit that replaces LSIs appears due to advances in or derivations from semiconductor technology, that technology may be used for integration of the functional blocks. Bio-technology is one possible application.

(9) The present invention may be any combination of the above-described embodiment and modifications.

### INDUSTRIAL APPLICABILITY

The present invention can be used for managerially, in other words, repeatedly and continuously, in an industry that manufactures and sells electrical devices that perform transfer of various information according to serial communication that does not use error correction information.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. A reception apparatus that receives a signal from a transmission apparatus via a signal wire, comprising:
a storage unit operable to store a plurality of types of available blocks;
a reception unit operable to receive a signal that expresses a transmission bit stream, the signal expressing the transmission bit stream using, in accordance with each of pieces of bit data of the transmission bit string, two types of rectangular waves that differ from each other in terms of how long a low level period continues;
a detection unit operable to, with respect to each rectangular wave in the received signal, measure how long the low level period continues and determine whether or not a piece of bit data is detectable according to the measured length, and when the piece of bit data is judged to be detectable, generate a piece of bit data corresponding to the measured low level period;
a repairing unit operable to, in a reception bit string composed of the generated one or more pieces of bit data, insert, into a bit position corresponding to a rectangular wave for which a piece of bit data is judged to be undetectable, a bit value 0 to generate a first repaired block and a bit value 1 to generate a second repaired block; and
a selection unit operable to search the storage unit for one or more available blocks matching at least one of the first repaired block and the second repaired block, and when an available block is found that matches one of the repaired blocks and no available block is found that matches the other one of the repaired blocks, select the one of the repaired blocks for which the matching available block was found.

2. The reception apparatus of claim 1, wherein
the storage unit stores one or more available block tables identified by (i) identification information showing a device to which the reception apparatus is connected via a signal wire, and (ii) status information showing an operational status of the reception apparatus, each of the available blocks corresponding respectively to the available block tables, and
the selection unit includes:
a status acquiring sub-unit operable to acquire status information showing a current operational status of the reception apparatus;
an identification sub-unit operable to acquire device identification information identifying the transmission apparatus;
a selection sub-unit operable to select, from among the stored available block tables, one available block table identified by the acquired status information and the acquired device identification information; and
a search unit operable to search selected available block table for one or more available blocks matching at least one of the first repaired block and the second repaired block, and when an available block is found that matches one of the repaired blocks and no available block is found that matches the other one of the repaired blocks, select the one of the repaired blocks for which the matching available block was found.

3. A reception apparatus that receives, from a transmission apparatus via a signal wire, a rectangular wave including a low level period corresponding to a piece of bit data, and corrects an error that occurs in the received rectangular wave, comprising:
a reception unit operable to receive the rectangular wave;
a measuring unit operable to measure a length of the low level period of the received rectangular wave;
a conversion unit operable to generate a first value when the measured length falls within a first range, and generate a second value when the measured length falls within a second range, the second range including a lower limit value that is greater than an upper limit value of the first range; and
a repairing unit operable to, when the measured length falls within neither of the first range and the second range, (a) lower a lower limit value of the first range to extend the first range, determine whether or not the measured length falls within the extended first range, and when it is determined that the measured length falls within the extended first range, generate the first value, and (b) raise the upper limit value of the second range to extend the second range, determine whether or not the measured length falls within the extended second range, and when it is determined that the measured length falls within the extended second range, generate the second value.

4. A transmission apparatus that transmits, to a reception apparatus via a signal wire, a rectangular wave including a low level period corresponding to a piece of bit data, comprising:
a signal output unit operable to repeatedly perform generation and output of a rectangular wave that includes a low level period corresponding to a piece of bit data;
a judgment unit operable to judge whether or not an error has occurred in the transmitted rectangular wave; and
a timing adjustment unit operable to, when an error is judged to have occurred in the transmitted rectangular wave, cause the signal output unit to shorten a length of the low level period.

5. A reception apparatus that receives a signal from a transmission apparatus via a signal wire, comprising:
a test reception unit operable to receive a test signal generated using, in accordance with each of test bits that compose test data, two types of rectangular waves that differ from each other in terms of how long a low level period continues;
a detection unit operable to detect dispersion of the low level period of each rectangular wave composing the received test signal;
a generation unit operable to generate a correction value based on dispersion detected with respect to all the rectangular waves; and
a correction unit operable to, using the correction value, correct each rectangular wave in the signal received from the transmission apparatus.

6. The reception apparatus of claim 5, wherein
the detection unit stores the test data and a low level period of each test bit, and, for each rectangular wave in the test signal, detects, as the dispersion, a difference between the low level period of the rectangular wave and the low level period of a corresponding one of the test bits, and
the generation unit generates the correction value by averaging all of the differences detected with respect to the rectangular waves composing the test signal.

7. A reception method used in a reception apparatus that receives a signal from a transmission apparatus via a signal wire, the reception apparatus including a storage unit operable to store a plurality of types of available blocks, the reception method comprising:
a reception step of receiving a signal that expresses a transmission bit stream, the signal expressing the transmission bit stream using, in accordance with each of pieces of bit data of the transmission bit string, two types of rectangular waves that differ from each other in terms of how long a low level period continues;
a detection step of detecting, with respect to each rectangular wave in the received signal, measure how long the low level period continues and determine whether or not a piece of bit data is detectable according to the measured length, and when the piece of bit data is judged to be detectable, generating a piece of bit data corresponding to the measured low level period;
a repairing step of, in a reception bit string composed of the generated one or more pieces of bit data, inserting, into a bit position corresponding to a rectangular wave for which a piece of bit data is judged to be undetectable, a bit value 0 to generate a first repaired block and a bit value 1 to generate a second repaired block; and
a selection step of searching the storage unit for one or more available blocks matching at least one of the first repaired block and the second repaired block, and when an available block is found that matches one of the repaired blocks and no available block is found that matches the other one of the repaired blocks, selecting the one of the repaired blocks for which the matching available block was found.

8. An integrated circuit provided in a reception apparatus that receives a signal from a transmission apparatus via a signal wire, the integrated circuit comprising:
a storage unit operable to store a plurality of types of available blocks;
a reception unit operable to receive a signal that expresses a transmission bit stream, the signal expressing the transmission bit stream using, in accordance with each of pieces of bit data of the transmission bit string, two types of rectangular waves that differ from each other in terms of how long a low level period continues;
a detection unit operable to, with respect to each rectangular wave in the received signal, measure how long the low level period continues and determine whether or not a piece of bit data is detectable according to the measured length, and when the piece of bit data is judged to be detectable, generate a piece of bit data corresponding to the measured low level period;
a repairing unit operable to, in a reception bit string composed of the generated one or more pieces of bit data, insert, into a bit position corresponding to a rectangular wave for which a piece of bit data is judged to be undetectable, a bit value 0 to generate a first repaired block and a bit value 1 to generate a second repaired block; and
a selection unit operable to search the storage unit for one or more available blocks matching at least one of, the first repaired block and the second repaired block, and when an available block is found that matches one of the repaired blocks and no available block is found that matches the other one of the repaired blocks, select the one of the repaired blocks for which the matching available block was found.

9. A reception method used in a reception apparatus that receives, from a transmission apparatus via a signal wire, a rectangular wave including a low level period corresponding to a piece of bit data, and corrects an error that occurs in the received rectangular wave, the reception method comprising:
a reception step of receiving the rectangular wave;
a measuring step of measuring a length of the low level period of the received rectangular wave;
a conversion step of generating a first value when the measured length falls within a first range, and generating a second value when the measured length falls within a second range, the second range including a lower limit value that is greater than an upper limit value of the first range; and
a repairing step of, when the measured length falls within neither of the first range and the second range, (a) lowering a lower limit value of the first range to extend the first range, determine whether or not the measured length falls within the extended first range, and when it is determined that the measured length falls within the extended first range, generate the first value, and (b) raising the upper limit value of the second range to extend the second range, determine whether or not the measured length falls within the extended second range, and when it is determined that the measured length falls within the extended second range, generating the second value.

10. An integrated circuit provided in a reception apparatus that receives, from a transmission apparatus via a signal wire, a rectangular wave including a low level period corresponding to a piece of bit data, and corrects an error that occurs in the received rectangular wave, the integrated circuit comprising:
a reception unit operable to receive the rectangular wave;
a measuring unit operable to measure a length of the low level period of the received rectangular wave;
a conversion unit operable to generate a first value when the measured length falls within a first range, and generate a second value when the measured length falls within a second range, the second range including a lower limit value that is greater than an upper limit value of the first range; and
a repairing unit operable to, when the measured length falls within neither of the first range and the second range, (a) lower a lower limit value of the first range to extend the first range, determine whether or not the measured length falls within the extended first range, and when it is determined that the measured length falls within the extended first range, generate the first value, and (b) raise the upper limit value of the second range to extend the second range, determine whether or not the measured length falls within the extended second range, and when it is determined that the measured length falls within the extended second range, generate the second value.

11. A transmission method used in a transmission apparatus that transmits, to a reception apparatus via a signal wire, a rectangular wave including a low level period corresponding to a piece of bit data, the transmission method comprising:
a signal output step of repeatedly performing generation and output of a rectangular wave that includes a low level period corresponding to a piece of bit data;
a judgment step of judging whether or not an error has occurred in the transmitted rectangular wave; and
a timing adjustment step of, when an error is judged to have occurred in the transmitted rectangular wave, causing the signal output unit to shorten a length of the low level period.

12. An integrated circuit provided in a transmission apparatus that transmits, to a reception apparatus via a signal wire, a rectangular wave including a low level period corresponding to a piece of bit data, the integrated circuit comprising:
a signal output unit operable to repeatedly perform generation and output of a rectangular wave that includes a low level period corresponding to a piece of bit data;
a judgment unit operable to judge whether or not an error has occurred in the transmitted rectangular wave; and
a timing adjustment unit operable to, when an error is judged to have occurred in the transmitted rectangular wave, cause the signal output unit to shorten a length of the low level period.

13. A reception method used in a reception apparatus that receives a signal from a transmission apparatus via a signal wire, the reception method comprising:
a test reception step of receiving a test signal generated using, in accordance with each of test bits that compose test data, two types of rectangular waves that differ from each other in terms of how long a low level period continues;
a detection step of detecting dispersion of the low level period of each rectangular wave composing the received test signal;
a generation step of generating a correction value based on dispersion detected with respect to all the rectangular waves; and
a correction step of, using the correction value, correcting each rectangular wave in the signal received from the transmission apparatus.

14. An integrated circuit provided in a reception apparatus that receives a signal from a transmission apparatus via a signal wire, the integrated circuit comprising:
a test reception unit operable to receive a test signal generated using, in accordance with each of test bits that compose test data, two types of rectangular waves that differ from each other in terms of how long a low level period continues;
a detection unit operable to detect dispersion of the low level period of each rectangular wave composing the received test signal;
a generation unit operable to generate a correction value based on dispersion detected with respect to all the rectangular waves; and
a correction unit operable to, using the correction value, correct each rectangular wave in the signal received from the transmission apparatus.
